(19) United States
(12) Patent Application Publication
(10) Pub. No.: US 2026/0172209 A1
(43) Pub. Date: Jun. 18, 2026

(54) Communication Method and Communication Apparatus

(71) Applicant: HUAWEI TECHNOLOGIES CO., LTD., Shenzhen (CN)

(72) Inventors: Lei Liu, Shanghai (CN); Xiaoyan Bi, Shanghai (CN); Jianglei Ma, Ottawa (CA); Yiqun Ge, Ottawa (CA); Wuxian Shi, Ottawa (CA)

(73) Assignee: HUAWEI TECHNOLOGIES CO., LTD., Shenzhen (CN)

(21) Appl. No.: 19/531,036

(22) Filed: Feb. 5, 2026

Related U.S. Application Data
(63) Continuation of application No. PCT/CN2023/113418, filed on Aug. 16, 2023.

(51) Int. Cl. H04L 5/00

(52) U.S. Cl. CPC H04L 5/0094; H04L 5/0023

(57) ABSTRACT

In a communication method, a first apparatus may receive first indication information indicative of M orthogonal vectors, where there is a mapping relationship between the M orthogonal vectors and a first resource pattern of a reference signal. The first apparatus may derive the first resource pattern of the reference signal based on the M orthogonal vectors indicated by the first indication information, to flexibly indicate the resource pattern of the reference signal. Additionally, a plurality of candidate orthogonal vectors or a method for generating a plurality of candidate orthogonal vectors may be predefined in this application. In this case, the first indication information indicates the M orthogonal vectors in the plurality of candidate orthogonal vectors.

### CROSS-REFERENCE TO RELATED APPLICATIONS

This is a continuation of International Patent Application No. PCT/CN2023/113418 filed on Aug. 16, 2023, which is hereby incorporated by reference in its entirety.

### TECHNICAL FIELD

This disclosure relates to the field of communication technologies, and in particular, to a communication method and a communication apparatus.

### BACKGROUND

Currently, to support a multi-antenna multiple-input multiple-output (MIMO) technology with ultra-high-dimensional receive/transmit antenna ports and ultra-wide bandwidths, a first reference signal (RS) resource pattern used for data transmission and channel state information (CSI) collection is designed. Based on the design, RS resource overheads can be significantly reduced while achieving good performance. The first RS resource pattern (namely, a first resource pattern of an RS) is irregularly scattered across one or more of time domain, frequency domain, and spatial domain. For example, the RS is sent only through some transmit antenna ports, or each RS port occupies some resources in only frequency domain/time domain to send the RS. However, when the first RS resource pattern is irregularly scattered across one or more of time domain, frequency domain, and spatial domain, indication overheads of the RS resource pattern increases dramatically. How to reduce indication overheads of RSs becomes a problem to be resolved.

### SUMMARY

This disclosure provides a communication method and a communication apparatus. Indication overheads of an RS resource pattern can be reduced by using the method.

According to a first aspect, this disclosure provides a communication method. The method is performed by a first apparatus. The first apparatus may be a terminal, or may be a component (for example, a processor, a chip, or a chip system) of the terminal, or may be a logical module that can implement all or a part of functions of the terminal. The first apparatus receives first indication information, where the first indication information indicates M orthogonal vectors, and there is a mapping relationship between the M orthogonal vectors and a first resource pattern of an RS. The first apparatus determines the first resource pattern of the RS based on the first indication information.

In the method, the first apparatus may receive the first indication information, where the first indication information may indicate the M orthogonal vectors, and there is a mapping relationship between the M orthogonal vectors and the first resource pattern of the RS. The first apparatus may derive the first resource pattern of the RS based on the M orthogonal vectors indicated by the first indication information. Optionally, the one or more orthogonal vectors indicated by the first indication information received by the first apparatus may be changed (for example, a transmitter of the first indication information may change the one or more orthogonal vectors indicated by the first indication information), to flexibly indicate the resource pattern of the RS. In addition, a plurality of candidate orthogonal vectors or a method for generating a plurality of candidate orthogonal vectors may be predefined. In this case, the first indication information indicates the M orthogonal vectors in the plurality of candidate orthogonal vectors. Compared with a direct indication of the RS resource pattern, the indication of the M orthogonal vectors can significantly reduce indication overheads.

In a possible implementation, the first indication information includes indexes and/or dimensions of the M orthogonal vectors; or the first indication information includes a first moment, and the first moment corresponds to indexes and/or dimensions of the M orthogonal vectors.

In the method, the plurality of candidate orthogonal vectors or the method for generating a plurality of candidate orthogonal vectors may be predefined. In this case, the first indication information indicates the indexes and/or the dimensions of the M orthogonal vectors in the plurality of candidate orthogonal vectors. Compared with a direct indication of the resource pattern of the RS, the indication of the indexes and/or the dimensions of the M orthogonal vectors can significantly reduce indication overheads. Optionally, the first indication information may further include the first moment (for example, a specified moment, where the moment may be a moment before a current moment), and the first moment corresponds to the indexes and/or the dimensions of the M orthogonal vectors. When the first indication information includes the first moment, it is equivalent to that the first indication information indicates the M orthogonal vectors corresponding to the first moment.

In a possible implementation, the M orthogonal vectors belong to one orthogonal vector set, all orthogonal vectors in the orthogonal vector set correspond to a same candidate resource of the RS, the candidate resource of the RS includes resources in one or more domains, and the one or more domains includes one or more of time domain, frequency domain, and spatial domain. The candidate resource of the RS is a set of resources that can be used to send or receive the RS.

In a possible implementation, a resource included in the first resource pattern of the RS belongs to the candidate resource of the RS, and there is a mapping relationship between a dimension of each of the M orthogonal vectors and a number of resources in the candidate resource of the RS.

In a possible implementation, that there is the mapping relationship between the dimension of each of the M orthogonal vectors and the number of resources in the candidate resource of the RS includes: if the candidate resource includes a resource in one domain, the dimension of each of the M orthogonal vectors is a number of resources in the resource in the domain; and if the candidate resource includes resources in a plurality of domains, the dimension of each of the M orthogonal vectors is a product of numbers of resources in the resources in the plurality of domains.

In the foregoing method, it is assumed that each of the M orthogonal vectors corresponds to the same candidate resource of the RS. In this case, the M orthogonal vectors belong to one orthogonal vector set. There is a mapping relationship between the first resource pattern of the RS and the M orthogonal vectors included in the orthogonal vector set.

In a possible implementation, the first resource pattern of the RS is a resource pattern formed by candidate resources corresponding to a group of linearly irrelevant row vectors of a first sub-unitary matrix. The first sub-unitary matrix is formed by arranging the M orthogonal vectors by column, and there is a one-to-one mapping relationship between the row vector of the first sub-unitary matrix and the candidate resource of the RS.

In a possible implementation, the first resource pattern of the RS is a resource pattern formed by candidate resources corresponding to a group of linearly irrelevant column vectors of a first sub-unitary matrix. The first sub-unitary matrix is formed by arranging the M orthogonal vectors by row, and there is a one-to-one mapping relationship between the column vector of the first sub-unitary matrix and the candidate resource of the RS.

In a possible implementation, the first apparatus arranges the M orthogonal vectors by column, to form the first sub-unitary matrix, and there is a one-to-one mapping relationship between the row vector of the first sub-unitary matrix and the candidate resource of the RS. The first apparatus selects a group of linearly irrelevant row vectors from the first sub-unitary matrix, and the resource pattern including the candidate resource corresponding to the group of linearly irrelevant row vectors is the first resource pattern of the RS.

In a possible implementation, the first apparatus arranges the M orthogonal vectors by row, to form the first sub-unitary matrix, and there is a one-to-one mapping relationship between the column vector of the first sub-unitary matrix and the candidate resource of the RS. The first apparatus selects a group of linearly irrelevant column vectors from the first sub-unitary matrix, and a resource pattern formed by candidate resources corresponding to the group of linearly irrelevant column vectors is the first resource pattern of the RS.

In the foregoing method, the first apparatus may determine the first resource pattern of the RS based on a predefined method for determining a resource pattern of an RS based on one orthogonal vector set. For example, the M orthogonal vectors are arranged by row or by column, to form the first sub-unitary matrix, and then the corresponding first resource pattern of the RS is determined based on the first sub-unitary matrix, so that the resource pattern of the RS is derived based on the first indication information.

In a possible implementation, the M orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of different candidate resources of the RS, the candidate resource of the RS includes resources in one or more domains, and the one or more domains includes one or more of time domain, frequency domain, and spatial domain.

In a possible implementation, a resource included in the first resource pattern of the RS belongs to the resources included in the combination of the candidate resources of the RS that correspond to the plurality of orthogonal vector sets. There is a mapping relationship between a dimension of each orthogonal vector in any one of the plurality of orthogonal vector sets and a number of resources in a candidate resource corresponding to the orthogonal vector set.

In a possible implementation, that there is the mapping relationship between the dimension of each orthogonal vector in any one of the plurality of orthogonal vector sets and the number of resources in the candidate resource corresponding to the orthogonal vector set includes: if the candidate resource corresponding to the any orthogonal vector set includes a resource in one domain, the dimension of each orthogonal vector in the orthogonal vector set is a number of resources in the resource in the domain; and if the candidate resource corresponding to the any orthogonal vector set includes resources in a plurality of domains, the dimension of each orthogonal vector in the orthogonal vector set is a product of numbers of resources in the resources in the plurality of domains.

In the foregoing method, it is assumed that the M orthogonal vectors belong to the plurality of orthogonal vector sets, and the plurality of orthogonal vector sets respectively correspond to the resources included in the combination of the candidate resources of the RS. For example, a 1^{st} orthogonal vector set may correspond to a resource in one domain, for example, frequency domain, and a 2^{nd} orthogonal vector set corresponds to a resource in one domain, for example, spatial domain. Candidate resources of the RS that correspond to the two orthogonal vector sets are resources included in a combination of a frequency domain resource and a spatial domain resource, and the resource included in the first resource pattern of the RS belongs to the candidate resources of the RS.

In a possible implementation, the first resource pattern of the RS is a resource pattern formed by candidate resources corresponding to a group of linearly irrelevant row vectors of a second sub-unitary matrix. There is a one-to-one mapping relationship between the row vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by column, and there is a one-to-one mapping relationship between a row vector of the first sub-unitary matrix and a candidate resource, of the RS, corresponding to the orthogonal vector set.

In a possible implementation, the first resource pattern of the RS is a resource pattern formed by candidate resources corresponding to a group of linearly irrelevant column vectors of a second sub-unitary matrix. There is a one-to-one mapping relationship between the column vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by row, and there is a one-to-one mapping relationship between a column vector of the first sub-unitary matrix and a candidate resource, of the RS, corresponding to the orthogonal vector set.

In a possible implementation, the first apparatus arranges, according to a predefined arrangement rule, the plurality of orthogonal vector sets to which the M orthogonal vectors belong, to separately form the plurality of first sub-unitary matrices by column, and there is a one-to-one mapping relationship between a row vector of a first sub-unitary matrix and a candidate resource, of the RS, corresponding to one orthogonal vector set. The first apparatus performs Kronecker product processing on the plurality of first sub-unitary matrices, to obtain one second sub-unitary matrix, and there is a one-to-one mapping relationship between a row vector of the second sub-unitary matrix and the resources included in the combination of the candidate resources of the RS that correspond to the plurality of orthogonal vector sets. The first apparatus selects a group of linearly irrelevant row vectors from the second sub-unitary matrix, and a resource pattern formed by candidate resources corresponding to the group of linearly irrelevant row vectors is the first resource pattern of the RS.

In a possible implementation, the first apparatus arranges, according to a predefined arrangement rule, the plurality of orthogonal vector sets to which the M orthogonal vectors belong, to separately form the plurality of first sub-unitary matrices by row, and there is a one-to-one mapping relationship between a column vector of a first sub-unitary matrix and a candidate resource, of the RS, corresponding to one orthogonal vector set. The first apparatus performs Kronecker product processing on the plurality of first sub-unitary matrices, to obtain one second sub-unitary matrix, and there is a one-to-one mapping relationship between a column vector of the second sub-unitary matrix and the resources included in the combination of the candidate resources of the RS that correspond to the plurality of orthogonal vector sets. The first apparatus selects a group of linearly irrelevant column vectors from the second sub-unitary matrix, and a resource pattern formed by candidate resources corresponding to the group of linearly irrelevant column vectors is the first resource pattern of the RS.

In the foregoing method, the first apparatus may determine the first resource pattern of the RS based on a predefined method for determining a resource pattern of an RS based on a plurality of orthogonal vector sets. For example, the plurality of orthogonal vector sets to which the M orthogonal vectors belong are arranged by row or by column, to form the plurality of first sub-unitary matrices, and then the second sub-unitary matrix is determined based on the plurality of first sub-unitary matrices, so that the corresponding first resource pattern of the RS is determined based on the second sub-unitary matrix. Therefore, the resource pattern of the RS is derived based on the first indication information.

In a possible implementation, the first apparatus determines second indication information, where the second indication information indicates N orthogonal vectors. There is a mapping relationship between N orthogonal vectors and a second resource pattern of the RS, where N is a positive integer. The first apparatus sends the second indication information.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In the foregoing method, the first apparatus may determine an appropriate second resource pattern of the RS (for example, based on channel information obtained based on a historical RS or sensing signal), and determine the N orthogonal vectors based on the second resource pattern. There is a mapping relationship between N orthogonal vectors and the second resource pattern of the RS. The resource pattern may be the same as or different from the first resource pattern. For example, the first apparatus determines the N orthogonal vectors. It is assumed that the N orthogonal vectors are different from the M orthogonal vectors. In this case, the first apparatus needs to receive the first indication information, to obtain the M orthogonal vectors. If the N orthogonal vectors are the same as the M orthogonal vectors, the first apparatus may receive the first indication information, or may not need to receive the first indication information. The first indication information does not need to be received, to reduce signaling overheads.

In the implementation in which the first apparatus determines and sends the second indication information, the first apparatus determines the first resource pattern of the RS based on the second indication information.

In the method, the first apparatus may send the second indication information to the second apparatus. It is assumed that the second apparatus does not send the first indication information to the first apparatus. In this case, the first apparatus may directly determine, based on the second indication information, that a resource pattern corresponding to the N orthogonal vectors indicated by the second indication information is the first resource pattern of the RS.

In the implementation in which the first apparatus determines and sends the second indication information, if the M orthogonal vectors are the same as the N orthogonal vectors, the second apparatus does not need to send the first indication information. If the first apparatus does not receive the first indication information, the first apparatus determines the first resource pattern of the RS based on the second indication information.

In the implementation in which the first apparatus determines and sends the second indication information, if the M orthogonal vectors are different from the N orthogonal vectors, the second apparatus sends the first indication information. If the first apparatus receives the first indication information, the first apparatus determines the first resource pattern of the RS based on the first indication information.

In a possible implementation, the first apparatus receives third indication information, where the third indication information indicates one or more bandwidth resources. The one or more bandwidth resources are associated with the first resource pattern.

In a possible implementation, the plurality of bandwidth resources include a first bandwidth resource and a second bandwidth resource, and a resource pattern corresponding to the second bandwidth resource is the same as a resource pattern corresponding to the first bandwidth resource, or first indication information corresponding to the second bandwidth resource is the same as first indication information corresponding to the first bandwidth resource, or one or more orthogonal vectors corresponding to the second bandwidth resource are the same as one or more orthogonal vectors corresponding to the first bandwidth resource.

In the foregoing method, the first apparatus may further receive the third indication information indicating the one or more bandwidth resources, and the one or more bandwidth resources are associated with the first resource pattern. For example, it is assumed that the plurality of bandwidth resources may correspond to a same resource pattern, that is, the plurality of bandwidth resources may correspond to same first indication information or a same orthogonal vector. This helps reduce indication overheads of the resource pattern of the RS.

In a possible implementation, the first apparatus sends fourth indication information, where the fourth indication information indicates one or more bandwidth resources. The one or more bandwidth resources are associated with the second resource pattern.

In a possible implementation, the plurality of bandwidth resources include a third bandwidth resource and a fourth bandwidth resource, and a resource pattern corresponding to the fourth bandwidth resource is the same as a resource pattern corresponding to the third bandwidth resource, or second indication information corresponding to the fourth bandwidth resource is the same as second indication information corresponding to the third bandwidth resource, or one or more orthogonal vectors corresponding to the fourth bandwidth resource are the same as one or more orthogonal vectors corresponding to the third bandwidth resource.

In the foregoing method, for the second indication information determined and sent by the first apparatus and the second resource pattern, of the RS, corresponding to the second indication information, the first apparatus may further send the fourth indication information indicating the one or more bandwidth resources. The one or more bandwidth resources are associated with the second resource pattern. For example, it is assumed that the plurality of bandwidth resources may correspond to a same resource pattern, that is, the plurality of bandwidth resources may correspond to same second indication information or a same orthogonal vector. This helps reduce indication overheads of the resource pattern of the RS.

In a possible implementation, the first indication information or the second indication information is configured by radio resource control (RRC), or is indicated by downlink control information (DCI) or a media access control control element (MAC-CE).

In the method, the first indication information or the second indication information may be configured by the RRC, or may be indicated by the DCI or the MAC-CE, that is, may be flexibly indicated.

In a possible implementation, an update period of the first indication information or the second indication information is periodic, aperiodic, or semi-persistent.

In the method, for different RSs (for example, periodic, aperiodic, or semi-persistent RSs), update periods of the first indication information or the second indication information are different.

In a possible implementation, the orthogonal vector set includes an orthogonal vector in a discrete Fourier transform (DFT) matrix, or a discrete cosine transform (DCT) matrix, or a Grassmannian manifold.

According to a second aspect, this disclosure provides a communication method. The method is performed by a second apparatus. The second apparatus may be a network device, or may be a component (for example, a processor, a chip, or a chip system) of the network device, or may be a logical module that can implement all or a part of functions of the network device. The second apparatus determines first indication information, where the first indication information indicates M orthogonal vectors, and there is a mapping relationship between the M orthogonal vectors and a first resource pattern of an RS. The second apparatus sends the first indication information.

In the method, the second apparatus may send the first indication information to a first apparatus, where the first indication information may indicate the M orthogonal vectors, and there is a mapping relationship between the M orthogonal vectors and the first resource pattern of the RS. Therefore, the second apparatus may flexibly indicate the resource pattern of the RS by changing one or more orthogonal vectors indicated by the first indication information. Compared with a direct indication of the RS resource pattern, the indication of the M orthogonal vectors can significantly reduce indication overheads of the RS.

In a possible implementation, the first indication information includes indexes and/or dimensions of the M orthogonal vectors; or the first indication information includes a first moment, and the first moment corresponds to indexes and/or dimensions of the M orthogonal vectors.

In the method, the plurality of candidate orthogonal vectors or the method for generating a plurality of candidate orthogonal vectors may be predefined. In this case, the first indication information indicates the indexes and/or the dimensions of the M orthogonal vectors in the plurality of candidate orthogonal vectors. Compared with a direct indication of the resource pattern of the RS, the indication of the indexes and/or the dimensions of the M orthogonal vectors can significantly reduce indication overheads. Optionally, the first indication information may further include the first moment (for example, a specified moment, where the moment may be a moment before a current moment), and the first moment corresponds to the indexes and/or the dimensions of the M orthogonal vectors. When the first indication information includes the first moment, it is equivalent to that the first indication information indicates the M orthogonal vectors corresponding to the first moment.

In a possible implementation, the M orthogonal vectors belong to one orthogonal vector set, all orthogonal vectors in the orthogonal vector set correspond to a same candidate resource of the RS, the candidate resource of the RS includes resources in one or more domains, and the one or more domains includes one or more of time domain, frequency domain, and spatial domain. The candidate resource of the RS is a set of resources that can be used to send or receive the RS.

In a possible implementation, a resource included in the first resource pattern of the RS belongs to the candidate resource of the RS, and there is a mapping relationship between a dimension of each of the M orthogonal vectors and a number of resources in the candidate resource of the RS.

In a possible implementation, that there is the mapping relationship between the dimension of each of the M orthogonal vectors and the number of resources in the candidate resource of the RS includes: if the candidate resource includes a resource in one domain, the dimension of each of the M orthogonal vectors is a number of resources in the resource in the domain; and if the candidate resource includes resources in a plurality of domains, the dimension of each of the M orthogonal vectors is a product of numbers of resources in the resources in the plurality of domains.

In the foregoing method, it is assumed that each of the M orthogonal vectors corresponds to the same candidate resource of the RS. In this case, the M orthogonal vectors belong to one orthogonal vector set. There is a mapping relationship between the first resource pattern of the RS and the M orthogonal vectors included in the orthogonal vector set.

In a possible implementation, the first resource pattern of the RS is a resource pattern formed by candidate resources corresponding to a group of linearly irrelevant row vectors of a first sub-unitary matrix. The first sub-unitary matrix is formed by arranging the M orthogonal vectors by column, and there is a one-to-one mapping relationship between the row vector of the first sub-unitary matrix and the candidate resource of the RS.

In a possible implementation, the first resource pattern of the RS is a resource pattern formed by candidate resources corresponding to a group of linearly irrelevant column vectors of a first sub-unitary matrix. The first sub-unitary matrix is formed by arranging the M orthogonal vectors by row, and there is a one-to-one mapping relationship between the column vector of the first sub-unitary matrix and the candidate resource of the RS.

In the foregoing method, the resource pattern of the RS may be determined based on one or more predefined orthogonal vectors. The orthogonal vector indicated by the second apparatus to the first apparatus may enable the first apparatus to derive the resource pattern of the RS.

In a possible implementation, the M orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of different candidate resources of the RS, the candidate resource of the RS includes resources in one or more domains, and the one or more domains includes one or more of time domain, frequency domain, and spatial domain.

In a possible implementation, a resource included in the first resource pattern of the RS belongs to the resources included in the combination of the candidate resources of the RS that correspond to the plurality of orthogonal vector sets. There is a mapping relationship between a dimension of each orthogonal vector in any one of the plurality of orthogonal vector sets and a number of resources in a candidate resource corresponding to the orthogonal vector set.

In a possible implementation, that there is the mapping relationship between the dimension of each orthogonal vector in any one of the plurality of orthogonal vector sets and the number of resources in the candidate resource corresponding to the orthogonal vector set includes: if the candidate resource corresponding to the any orthogonal vector set includes a resource in one domain, the dimension of each orthogonal vector in the orthogonal vector set is a number of resources in the resource in the domain; and if the candidate resource corresponding to the any orthogonal vector set includes resources in a plurality of domains, the dimension of each orthogonal vector in the orthogonal vector set is a product of numbers of resources in the resources in the plurality of domains.

In the foregoing method, it is assumed that the M orthogonal vectors belong to the plurality of orthogonal vector sets, and the plurality of orthogonal vector sets respectively correspond to the resources included in the combination of the candidate resources of the RS. For example, a 1^{st} orthogonal vector set may correspond to a resource in one domain, for example, frequency domain, and a 2^{nd} orthogonal vector set corresponds to a resource in one domain, for example, spatial domain. Candidate resources of the RS that correspond to the two orthogonal vector sets are resources included in a combination of a frequency domain resource and a spatial domain resource, and the resource included in the first resource pattern of the RS belongs to the candidate resources of the RS.

In a possible implementation, the first resource pattern of the RS is a resource pattern formed by candidate resources corresponding to a group of linearly irrelevant row vectors of a second sub-unitary matrix. There is a one-to-one mapping relationship between the row vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by column, and there is a one-to-one mapping relationship between a row vector of the first sub-unitary matrix and a candidate resource, of the RS, corresponding to the orthogonal vector set.

In a possible implementation, the first resource pattern of the RS is a resource pattern formed by candidate resources corresponding to a group of linearly irrelevant column vectors of a second sub-unitary matrix. There is a one-to-one mapping relationship between the column vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by row, and there is a one-to-one mapping relationship between a column vector of the first sub-unitary matrix and a candidate resource, of the RS, corresponding to the orthogonal vector set.

In the foregoing method, the resource pattern of the RS may be determined based on one or more predefined orthogonal vectors. The orthogonal vector indicated by the second apparatus to the first apparatus may enable the first apparatus to derive the resource pattern of the RS.

In a possible implementation, the second apparatus receives second indication information, where the second indication information indicates N orthogonal vectors. There is a mapping relationship between N orthogonal vectors and a second resource pattern of the RS, where N is a positive integer.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In the foregoing method, the second apparatus may receive the second indication information indicating the N orthogonal vectors, and the first apparatus determines (for example, based on channel information obtained based on a historical RS or sensing signal) that the resource pattern corresponding to the N orthogonal vectors is an appropriate second resource pattern of the RS. The N orthogonal vectors are determined based on the second resource pattern, there is a mapping relationship between N orthogonal vectors and the resource pattern of the RS, and the resource pattern may be the same as or different from the first resource pattern.

In a possible implementation, the second apparatus sends third indication information, where the third indication information indicates one or more bandwidth resources. The one or more bandwidth resources are associated with the first resource pattern.

In a possible implementation, the plurality of bandwidth resources include a first bandwidth resource and a second bandwidth resource, and a resource pattern corresponding to the second bandwidth resource is the same as a resource pattern corresponding to the first bandwidth resource, or first indication information corresponding to the second bandwidth resource is the same as first indication information corresponding to the first bandwidth resource, or one or more orthogonal vectors corresponding to the second bandwidth resource are the same as one or more orthogonal vectors corresponding to the first bandwidth resource.

In the foregoing method, the second apparatus may further send the third indication information indicating the one or more bandwidth resources, and the one or more bandwidth resources are associated with the first resource pattern. For example, it is assumed that the plurality of bandwidth resources may correspond to a same resource pattern, that is, the plurality of bandwidth resources may correspond to same first indication information or a same orthogonal vector. This helps reduce indication overheads of the resource pattern of the RS.

In a possible implementation, the second apparatus receives fourth indication information, where the fourth indication information indicates one or more bandwidth resources. The one or more bandwidth resources are associated with the second resource pattern.

In a possible implementation, the plurality of bandwidth resources include a third bandwidth resource and a fourth bandwidth resource, and a resource pattern corresponding to the fourth bandwidth resource is the same as a resource pattern corresponding to the third bandwidth resource, or second indication information corresponding to the fourth bandwidth resource is the same as second indication information corresponding to the third bandwidth resource, or one or more orthogonal vectors corresponding to the fourth bandwidth resource are the same as one or more orthogonal vectors corresponding to the third bandwidth resource.

In the foregoing method, for the second indication information determined and sent by the first apparatus and the second resource pattern, of the RS, corresponding to the second indication information, the second apparatus receives the fourth indication information indicating the one or more bandwidth resources. The one or more bandwidth resources are associated with the second resource pattern. For example, it is assumed that the plurality of bandwidth resources may correspond to a same resource pattern, that is, the plurality of bandwidth resources may correspond to same second indication information or a same orthogonal vector. This helps reduce indication overheads of the resource pattern of the RS.

In a possible implementation, the first indication information or the second indication information is configured by RRC, or is indicated by DCI or a MAC-CE.

In the method, the first indication information or the second indication information may be configured by the RRC, or may be indicated by the DCI or the MAC-CE, that is, may be flexibly indicated.

In a possible implementation, an update period of the first indication information or the second indication information is periodic, aperiodic, or semi-persistent.

In the method, for different RSs (for example, periodic, aperiodic, or semi-persistent RSs), update periods of the first indication information or the second indication information are different.

In a possible implementation, the orthogonal vector set includes an orthogonal vector in a DFT matrix, or a DCT matrix, or a Grassmannian manifold.

According to a third aspect, this disclosure provides a communication method. The method is performed by a first apparatus. The first apparatus may be a terminal, or may be a component (for example, a processor, a chip, or a chip system) of the terminal, or may be a logical module that can implement all or a part of functions of the terminal. The first apparatus sends second indication information, where the second indication information indicates N orthogonal vectors, and there is a mapping relationship between the N orthogonal vectors and a second resource pattern of the RS. The first apparatus determines a first resource pattern of the RS based on the second indication information, where the first resource pattern is the same as the second resource pattern.

In the method, the first apparatus may determine an appropriate second resource pattern of the RS (for example, based on channel information obtained based on a historical RS or sensing signal), and determine the N orthogonal vectors based on the second resource pattern. There is a mapping relationship between N orthogonal vectors and the resource pattern of the RS. In addition, when the second resource pattern is the same as a first resource pattern, of the RS, determined by the second apparatus, the first apparatus does not need to receive the indication information, and may directly determine the first resource pattern of the RS based on the second indication information, to further reduce indication overheads of the RS.

In a possible implementation, when the first apparatus does not receive first indication information in a preset time period after sending the second indication information, the first apparatus determines the first resource pattern of the RS based on the second indication information.

In the method, a condition that the first apparatus determines that the second resource pattern is the same as the first resource pattern may be that the first apparatus does not receive the first indication information in a detection time period after sending the second indication information. In this case, the first apparatus may not receive the first indication information, and directly determine the first resource pattern of the RS.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In a possible implementation, the second indication information is configured by RRC, or is indicated by DCI or a MAC-CE.

In a possible implementation, an update period of the second indication information is periodic, aperiodic, or semi-persistent.

According to a fourth aspect, this disclosure provides a communication apparatus. The communication apparatus may be a terminal, or may be an apparatus in the terminal, or may be an apparatus that can be used in combination with the terminal. In a possible implementation, the communication apparatus may include a functional module. The functional module may be implemented by a hardware circuit, software, or a combination of a hardware circuit and software.

In a possible implementation, the communication apparatus includes a communication unit and a processing unit. The communication unit is configured to receive first indication information, where the first indication information indicates M orthogonal vectors, and there is a mapping relationship between the M orthogonal vectors and a first resource pattern of an RS. The processing unit is configured to determine the first resource pattern of the RS based on the first indication information.

In a possible implementation, the first indication information includes indexes and/or dimensions of the M orthogonal vectors; or the first indication information includes a first moment, and the first moment corresponds to indexes and/or dimensions of the M orthogonal vectors.

In a possible implementation, the M orthogonal vectors belong to one orthogonal vector set, all orthogonal vectors in the orthogonal vector set correspond to a same candidate resource of the RS, the candidate resource of the RS includes resources in one or more domains, and the one or more domains includes one or more of time domain, frequency domain, and spatial domain. The candidate resource of the RS is a set of resources that can be used to send or receive the RS.

In a possible implementation, the candidate resource of the RS includes a resource corresponding to the first resource pattern of the RS, and there is a mapping relationship between a dimension of each of the M orthogonal vectors and a number of resources in the candidate resource of the RS.

In a possible implementation, that there is the mapping relationship between the dimension of each of the M orthogonal vectors and the number of resources in the candidate resource of the RS includes: if the candidate resource includes a resource in one domain, the dimension of each of the M orthogonal vectors is a number of resources in the resource in the domain; and if the candidate resource includes resources in a plurality of domains, the dimension of each of the M orthogonal vectors is a product of numbers of resources in the resources in the plurality of domains.

In a possible implementation, the first resource pattern of the RS is a resource pattern formed by candidate resources corresponding to a group of linearly irrelevant row vectors of a first sub-unitary matrix. The first sub-unitary matrix is formed by arranging the M orthogonal vectors by column, and there is a one-to-one mapping relationship between the row vector of the first sub-unitary matrix and the candidate resource of the RS.

In a possible implementation, the first resource pattern of the RS is a resource pattern formed by candidate resources corresponding to a group of linearly irrelevant column vectors of a first sub-unitary matrix. The first sub-unitary matrix is formed by arranging the M orthogonal vectors by row, and there is a one-to-one mapping relationship between the column vector of the first sub-unitary matrix and the candidate resource of the RS.

In a possible implementation, the processing unit is configured to arrange the M orthogonal vectors by column, to form the first sub-unitary matrix, and there is a one-to-one mapping relationship between the row vector of the first sub-unitary matrix and the candidate resource of the RS. The processing unit is further configured to select a group of linearly irrelevant row vectors from the first sub-unitary matrix, and the resource pattern including the candidate resource corresponding to the group of linearly irrelevant row vectors is the first resource pattern of the RS.

In a possible implementation, the processing unit is configured to arrange the M orthogonal vectors by row, to form the first sub-unitary matrix, and there is a one-to-one mapping relationship between the column vector of the first sub-unitary matrix and the candidate resource of the RS. The processing unit is further configured to select a group of linearly irrelevant column vectors from the first sub-unitary matrix, and a resource pattern formed by candidate resources corresponding to the group of linearly irrelevant column vectors is the first resource pattern of the RS.

In a possible implementation, the M orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of different candidate resources of the RS, the candidate resource of the RS includes resources in one or more domains, and the one or more domains includes one or more of time domain, frequency domain, and spatial domain.

In a possible implementation, a resource included in the first resource pattern of the RS belongs to the resources included in the combination of the candidate resources of the RS that correspond to the plurality of orthogonal vector sets. There is a mapping relationship between a dimension of each orthogonal vector in any one of the plurality of orthogonal vector sets and a number of resources in a candidate resource corresponding to the orthogonal vector set.

In a possible implementation, that there is the mapping relationship between the dimension of each orthogonal vector in any one of the plurality of orthogonal vector sets and the number of resources in the candidate resource corresponding to the orthogonal vector set includes: if the candidate resource corresponding to the any orthogonal vector set includes a resource in one domain, the dimension of each orthogonal vector in the orthogonal vector set is a number of resources in the resource in the domain; and if the candidate resource corresponding to the any orthogonal vector set includes resources in a plurality of domains, the dimension of each orthogonal vector in the orthogonal vector set is a product of numbers of resources in the resources in the plurality of domains.

In a possible implementation, the first resource pattern of the RS is a resource pattern formed by candidate resources corresponding to a group of linearly irrelevant row vectors of a second sub-unitary matrix. There is a one-to-one mapping relationship between the row vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by column, and there is a one-to-one mapping relationship between a row vector of the first sub-unitary matrix and a candidate resource, of the RS, corresponding to the orthogonal vector set.

In a possible implementation, the first resource pattern of the RS is a resource pattern formed by candidate resources corresponding to a group of linearly irrelevant column vectors of a second sub-unitary matrix. There is a one-to-one mapping relationship between the column vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by row, and there is a one-to-one mapping relationship between a column vector of the first sub-unitary matrix and a candidate resource, of the RS, corresponding to the orthogonal vector set.

In a possible implementation, the processing unit is configured to arrange, according to a predefined arrangement rule, the plurality of orthogonal vector sets to which the M orthogonal vectors belong, to separately form the plurality of first sub-unitary matrices by column, and there is a one-to-one mapping relationship between a row vector of a first sub-unitary matrix and a candidate resource, of the RS, corresponding to one orthogonal vector set. The processing unit is configured to perform Kronecker product processing on the plurality of first sub-unitary matrices, to obtain one second sub-unitary matrix, and there is a one-to-one mapping relationship between a row vector of the second sub-unitary matrix and the resources included in the combination of the candidate resources of the RS that correspond to the plurality of orthogonal vector sets. The processing unit is further configured to select a group of linearly irrelevant row vectors from the second sub-unitary matrix, and a resource pattern formed by candidate resources corresponding to the group of linearly irrelevant row vectors is the first resource pattern of the RS.

In a possible implementation, the processing unit is configured to arrange, according to a predefined arrangement rule, the plurality of orthogonal vector sets to which the M orthogonal vectors belong, to separately form the plurality of first sub-unitary matrices by row, and there is a one-to-one mapping relationship between a column vector of a first sub-unitary matrix and a candidate resource, of the RS, corresponding to one orthogonal vector set. The processing unit is further configured to perform Kronecker product processing on the plurality of first sub-unitary matrices, to obtain one second sub-unitary matrix, and there is a one-to-one mapping relationship between a column vector of the second sub-unitary matrix and the resources included in the combination of the candidate resources of the RS that correspond to the plurality of orthogonal vector sets. The processing unit is further configured to select a group of linearly irrelevant column vectors from the second sub-unitary matrix, and a resource pattern formed by candidate resources corresponding to the group of linearly irrelevant column vectors is the first resource pattern of the RS.

In a possible implementation, the processing unit is configured to determine second indication information, where the second indication information indicates N orthogonal vectors. There is a mapping relationship between N orthogonal vectors and a second resource pattern of the RS, where N is a positive integer. The communication unit is configured to send the second indication information.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In a possible implementation, the processing unit is configured to determine the first resource pattern of the RS based on the second indication information.

In a possible implementation, if the M orthogonal vectors are the same as the N orthogonal vectors, the communication unit does not need to send the first indication information. If the communication unit does not receive the first indication information, the processing unit is configured to determine the first resource pattern of the RS based on the second indication information.

In a possible implementation, if the M orthogonal vectors are different from the N orthogonal vectors, the communication unit is configured to send the first indication information. If the communication unit receives the first indication information, the processing unit is configured to determine the first resource pattern of the RS based on the first indication information.

In a possible implementation, the communication unit is configured to receive third indication information, where the third indication information indicates one or more bandwidth resources. The one or more bandwidth resources are associated with the first resource pattern.

In a possible implementation, the plurality of bandwidth resources include a first bandwidth resource and a second bandwidth resource, and a resource pattern corresponding to the second bandwidth resource is the same as a resource pattern corresponding to the first bandwidth resource, or first indication information corresponding to the second bandwidth resource is the same as first indication information corresponding to the first bandwidth resource, or one or more orthogonal vectors corresponding to the second bandwidth resource are the same as one or more orthogonal vectors corresponding to the first bandwidth resource.

In a possible implementation, the communication unit is configured to send fourth indication information, where the fourth indication information indicates one or more bandwidth resources. The one or more bandwidth resources are associated with the second resource pattern.

In a possible implementation, the plurality of bandwidth resources include a third bandwidth resource and a fourth bandwidth resource, and a resource pattern corresponding to the fourth bandwidth resource is the same as a resource pattern corresponding to the third bandwidth resource, or second indication information corresponding to the fourth bandwidth resource is the same as second indication information corresponding to the third bandwidth resource, or one or more orthogonal vectors corresponding to the fourth bandwidth resource are the same as one or more orthogonal vectors corresponding to the third bandwidth resource.

In a possible implementation, the first indication information or the second indication information is configured by RRC, or is indicated by DCI or a MAC-CE.

In a possible implementation, an update period of the first indication information or the second indication information is periodic, aperiodic, or semi-persistent.

In a possible implementation, the orthogonal vector set includes an orthogonal vector in a DFT matrix, or a DCT matrix, or a Grassmannian manifold.

According to a fifth aspect, this disclosure provides a communication apparatus. The communication apparatus may be a network device, an apparatus in the network device, or an apparatus that can be used in combination with the network device. In a possible implementation, the communication apparatus may include a functional module. The functional module may be implemented by a hardware circuit, software, or a combination of a hardware circuit and software.

In a possible implementation, the communication apparatus includes a communication unit and a processing unit. The processing unit is configured to determine first indication information, where the first indication information indicates M orthogonal vectors, and there is a mapping relationship between the M orthogonal vectors and a first resource pattern of an RS. The communication unit is configured to send the first indication information.

In a possible implementation, the first indication information includes indexes and/or dimensions of the M orthogonal vectors; or the first indication information includes a first moment, and the first moment corresponds to indexes and/or dimensions of the M orthogonal vectors.

In a possible implementation, the M orthogonal vectors belong to one orthogonal vector set, all orthogonal vectors in the orthogonal vector set correspond to a same candidate resource of the RS, the candidate resource of the RS includes resources in one or more domains, and the one or more domains includes one or more of time domain, frequency domain, and spatial domain.

In a possible implementation, a resource included in the first resource pattern of the RS belongs to the candidate resource of the RS, and there is a mapping relationship between a dimension of each of the M orthogonal vectors and a number of resources in the candidate resource of the RS.

In a possible implementation, that there is the mapping relationship between the dimension of each of the M orthogonal vectors and the number of resources in the candidate resource of the RS includes: if the candidate resource includes a resource in one domain, the dimension of each of the M orthogonal vectors is a number of resources in the resource in the domain; and if the candidate resource includes resources in a plurality of domains, the dimension of each of the M orthogonal vectors is a product of numbers of resources in the resources in the plurality of domains.

In a possible implementation, the first resource pattern of the RS is a resource pattern formed by candidate resources corresponding to a group of linearly irrelevant row vectors of a first sub-unitary matrix. The first sub-unitary matrix is formed by arranging the M orthogonal vectors by column, and there is a one-to-one mapping relationship between the row vector of the first sub-unitary matrix and the candidate resource of the RS.

In a possible implementation, the first resource pattern of the RS is a resource pattern formed by candidate resources corresponding to a group of linearly irrelevant column vectors of a first sub-unitary matrix. The first sub-unitary matrix is formed by arranging the M orthogonal vectors by row, and there is a one-to-one mapping relationship between the column vector of the first sub-unitary matrix and the candidate resource of the RS.

In a possible implementation, the M orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of different candidate resources of the RS, the candidate resource of the RS includes resources in one or more domains, and the one or more domains includes one or more of time domain, frequency domain, and spatial domain.

In a possible implementation, a resource included in the first resource pattern of the RS belongs to the resources included in the combination of the candidate resources of the RS that correspond to the plurality of orthogonal vector sets. There is a mapping relationship between a dimension of each orthogonal vector in any one of the plurality of orthogonal vector sets and a number of resources in a candidate resource corresponding to the orthogonal vector set.

In a possible implementation, that there is the mapping relationship between the dimension of each orthogonal vector in any one of the plurality of orthogonal vector sets and the number of resources in the candidate resource corresponding to the orthogonal vector set includes: if the candidate resource corresponding to the any orthogonal vector set includes a resource in one domain, the dimension of each orthogonal vector in the orthogonal vector set is a number of resources in the resource in the domain; and if the candidate resource corresponding to the any orthogonal vector set includes resources in a plurality of domains, the dimension of each orthogonal vector in the orthogonal vector set is a product of numbers of resources in the resources in the plurality of domains.

In a possible implementation, the first resource pattern of the RS is a resource pattern formed by candidate resources corresponding to a group of linearly irrelevant row vectors of a second sub-unitary matrix. There is a one-to-one mapping relationship between the row vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by column, and there is a one-to-one mapping relationship between a row vector of the first sub-unitary matrix and a candidate resource, of the RS, corresponding to the orthogonal vector set.

In a possible implementation, the first resource pattern of the RS is a resource pattern formed by candidate resources corresponding to a group of linearly irrelevant column vectors of a second sub-unitary matrix. There is a one-to-one mapping relationship between the column vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by row, and there is a one-to-one mapping relationship between a column vector of the first sub-unitary matrix and a candidate resource, of the RS, corresponding to the orthogonal vector set.

In a possible implementation, the communication unit is configured to receive second indication information, where the second indication information indicates N orthogonal vectors. There is a mapping relationship between N orthogonal vectors and a second resource pattern of the RS, where N is a positive integer.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In a possible implementation, the communication unit is configured to send third indication information, where the third indication information indicates one or more bandwidth resources. The one or more bandwidth resources are associated with the first resource pattern.

In a possible implementation, the plurality of bandwidth resources include a first bandwidth resource and a second bandwidth resource, and a resource pattern corresponding to the second bandwidth resource is the same as a resource pattern corresponding to the first bandwidth resource, or first indication information corresponding to the second bandwidth resource is the same as first indication information corresponding to the first bandwidth resource, or one or more orthogonal vectors corresponding to the second bandwidth resource are the same as one or more orthogonal vectors corresponding to the first bandwidth resource.

In a possible implementation, the communication unit is configured to receive fourth indication information, where the fourth indication information indicates one or more bandwidth resources. The one or more bandwidth resources are associated with the second resource pattern.

In a possible implementation, the plurality of bandwidth resources include a third bandwidth resource and a fourth bandwidth resource, and a resource pattern corresponding to the fourth bandwidth resource is the same as a resource pattern corresponding to the third bandwidth resource, or second indication information corresponding to the fourth bandwidth resource is the same as second indication information corresponding to the third bandwidth resource, or one or more orthogonal vectors corresponding to the fourth bandwidth resource are the same as one or more orthogonal vectors corresponding to the third bandwidth resource.

In a possible implementation, the first indication information or the second indication information is configured by RRC, or is indicated by DCI or a MAC-CE.

In a possible implementation, an update period of the first indication information or the second indication information is periodic, aperiodic, or semi-persistent.

In a possible implementation, the orthogonal vector set includes an orthogonal vector in a DFT matrix, or a DCT matrix, or a Grassmannian manifold.

According to a sixth aspect, this disclosure provides a communication apparatus. The communication apparatus may be a terminal, or may be an apparatus in the terminal, or may be an apparatus that can be used in combination with the terminal. In a possible implementation, the communication apparatus may include a functional module. The functional module may be implemented by a hardware circuit, software, or a combination of a hardware circuit and software.

In a possible implementation, the communication apparatus includes a communication unit and a processing unit. The communication unit is configured to send second indication information, where the second indication information indicates N orthogonal vectors, and there is a mapping relationship between the N orthogonal vectors and a second resource pattern of the RS. The processing unit is configured to determine a first resource pattern of the RS based on the second indication information, where the first resource pattern is the same as the second resource pattern.

In a possible implementation, when the communication unit does not receive first indication information in a preset time period after sending the second indication information, the processing unit is configured to determine the first resource pattern of the RS based on the second indication information.

In a possible implementation, the second indication information includes indexes and/or dimensions of the N orthogonal vectors; or the second indication information includes a second moment, and the second moment corresponds to indexes and/or dimensions of the N orthogonal vectors. The N orthogonal vectors are the same as or different from the M orthogonal vectors.

In a possible implementation, the second indication information is configured by RRC, or is indicated by DCI or a MAC-CE.

In a possible implementation, an update period of the second indication information is periodic, aperiodic, or semi-persistent.

For the fourth aspect to the sixth aspect, in an example, the processing unit may be a processor, and the communication unit may be a transceiver unit, a transceiver, or a communication interface. It may be understood that when the communication apparatus is a communication device (for example, a terminal or a network device), the communication unit may be a transceiver (for example, the transceiver includes a transmitter and a receiver) in the communication apparatus, for example, implemented by using an antenna, a feeder, and a codec in the communication apparatus. Alternatively, if the communication apparatus is a chip disposed in a device, the processing unit may be a processing circuit, a logic circuit, or the like of the chip, and the communication unit may be an input/output interface of the chip, for example, an input/output circuit or a pin.

According to a seventh aspect, this disclosure provides a communication apparatus, including a processor, configured to execute instructions. Optionally, the communication apparatus further includes a memory. The memory is configured to store the instructions. When the instructions are executed by the processor, the communication apparatus is enabled to implement the method in the first aspect and any possible implementation of the first aspect and the third aspect and any possible implementation of the third aspect. Optionally, the processor is coupled to the memory.

According to an eighth aspect, this disclosure provides another communication apparatus, including a processor, configured to execute instructions. Optionally, the communication apparatus further includes a memory. The memory is configured to store the instructions. When the instructions are executed by the processor, the communication apparatus is enabled to implement the method in the second aspect and any possible implementation of the second aspect. Optionally, the processor is coupled to the memory.

According to a ninth aspect, this disclosure provides a communication system. The communication system includes the plurality of apparatuses or devices in the fourth aspect to the eighth aspect, so that the apparatuses or devices perform the method in the first aspect to the third aspect and any possible implementation of the first aspect to the third aspect.

According to a tenth aspect, this disclosure provides a computer-readable storage medium. The computer-readable storage medium stores instructions. When the instructions are run on a computer, the computer is enabled to perform the method in the first aspect to the third aspect and any possible implementation of the first aspect to the third aspect.

According to an eleventh aspect, this disclosure provides a chip, and the chip includes a processor (or a logic circuit). Optionally, the chip may further include a communication interface (or an interface), configured to implement the method in the first aspect to the third aspect and any possible implementation of the first aspect to the third aspect. In a possible implementation, if the chip is the smallest processing unit in an entire system, the chip may be a processor, or may include a processor and a memory, or may include a processor, a memory, and a transceiver, to implement the method in the first aspect to the third aspect and any possible implementation of the first aspect to the third aspect.

According to a twelfth aspect, this disclosure provides a chip system. The chip system includes a processor and an interface. Optionally, the chip system may further include a memory. The chip system is configured to implement the method in the first aspect to the third aspect and any possible implementation of the first aspect to the third aspect. The chip system may include a chip, or may include a chip and another discrete component.

According to a thirteenth aspect, this disclosure provides a computer program product, including instructions. When the instructions are run on a computer, the computer is enabled to perform the method in the first aspect to the third aspect and any possible implementation of the first aspect to the third aspect.

### BRIEF DESCRIPTION OF DRAWINGS

FIG. 1 is a diagram of a communication system according to this disclosure;

FIG. 2 is a diagram of a first resource pattern of an RS according to this disclosure;

FIG. 3 is a schematic flowchart of a communication method according to this disclosure;

FIG. 4 is a diagram of determining a first resource pattern of an RS based on a candidate resource corresponding to a group of linearly irrelevant row vectors according to this disclosure;

FIG. 5 is a diagram of determining a first resource pattern of an RS based on a candidate resource corresponding to a group of linearly irrelevant column vectors according to this disclosure;

FIG. 6 is a diagram of a correspondence between a sub-unitary matrix and a candidate resource of an RS according to this disclosure;

FIG. 7 is a schematic flowchart of determining a resource pattern of a channel state information reference signal (CSI-RS) according to this disclosure;

FIG. 8A is another schematic flowchart of determining a resource pattern of a CSI-RS according to this disclosure;

FIG. 8B is still another schematic flowchart of determining a resource pattern of a CSI-RS according to this disclosure;

FIG. 8C and FIG. 8D are yet another schematic flowchart of determining a resource pattern of a CSI-RS according to this disclosure;

FIG. 9 is a schematic flowchart of determining a resource pattern of an SRS according to this disclosure;

FIG. 10 is a schematic flowchart of determining a resource pattern of a demodulation RS (DMRS) according to this disclosure;

FIG. 11 is a diagram in which a plurality of bandwidth resources correspond to a same resource pattern according to this disclosure;

FIG. 12 is a diagram in which a plurality of bandwidth resources correspond to different resource patterns according to this disclosure;

FIG. 13 is a diagram of a communication apparatus according to this disclosure; and

FIG. 14 is a diagram of another communication apparatus according to this disclosure.

### DESCRIPTION OF EMBODIMENTS

In embodiments of this disclosure, “/” may represent an “or” relationship between associated objects. For example, A/B may represent A or B. “And/or” may indicate that there are three relationships between associated objects. For example, A and/or B may represent the following three cases: only A exists, both A and B exist, and only B exists, where A and B may be singular or plural. For ease of describing technical solutions in embodiments of this disclosure, in embodiments of this disclosure, the terms such as “first” and “second” may be used to distinguish technical features with a same or similar function. The terms such as “first” and “second” do not limit a number and an execution sequence, and the terms such as “first” and “second” do not limit a definite difference. In embodiments of this disclosure, the word such as “example” or “for example” is used to represent an example, evidence, or a description. Any embodiment or design solution described as “example” or “for example” should not be explained as being more preferred or having more advantages than another embodiment or design solution. The word such as “example” or “for example” is used to present a related concept in a specific manner for ease of understanding.

The following describes the technical solutions in embodiments of this disclosure with reference to accompanying drawings in embodiments of this disclosure.

To reduce indication overheads of an RS, this disclosure provides a communication method. Indication overheads of an RS in massive antennas can be greatly reduced by using the communication method.

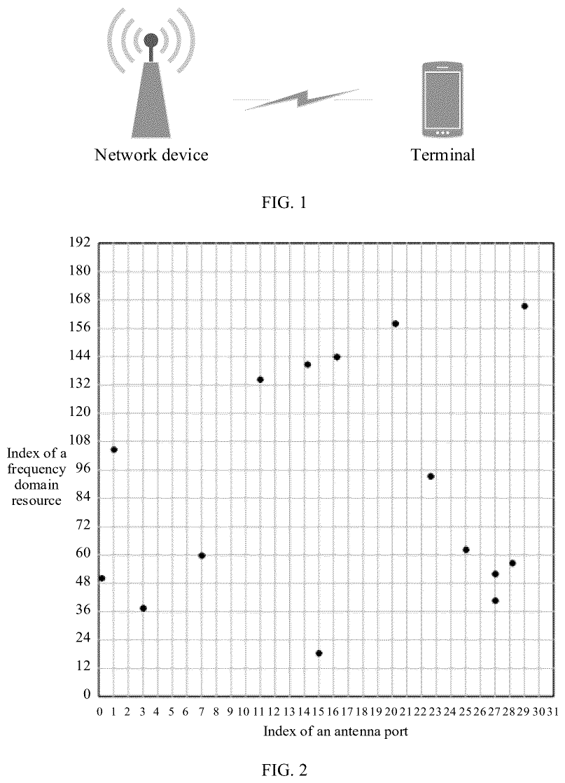

The communication method provided in this disclosure may be applied to a communication system shown in FIG. 1. For example, the communication system includes a network device and a terminal.

The communication system in this disclosure may include but is not limited to communication systems of various radio access technologies (RAT), for example, a narrowband Internet of things (NB-IoT) system, a Long-Term Evolution (LTE) communication system, a 5G (or referred to as new radio (NR)) communication system, and a transition system between the LTE communication system and the 5G communication system. The transition system may also be referred to as a 4.5G communication system. The communication system may alternatively be a future communication system, for example, a 6th generation (6G) system or even a 7th generation (7G) system. A network architecture and a service scenario described in embodiments of this disclosure are intended to describe the technical solutions in embodiments of this disclosure more clearly, and do not constitute any limitation on the technical solutions provided in embodiments of this disclosure. A person of ordinary skill in the art may know that with evolution of communication network architectures and emergence of new service scenarios, the technical solutions provided in embodiments of this disclosure are also applicable to similar technical problems.

The terminal is also referred to as a terminal device, user equipment (UE), a mobile station (MS), a mobile terminal (MT), or the like, and is a device that provides voice and/or data connectivity for a user, for example, a handheld device or a vehicle-mounted device having a wireless connection function. Currently, some examples of the terminal are: a mobile phone, a tablet computer, a notebook computer, a palmtop computer, a mobile Internet device (MID), a wearable device, an uncrewed aerial vehicle, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, a terminal in a 5G network, a terminal in a future evolved network, a terminal in a future communication system, or the like.

The network device in this disclosure is a radio access network (RAN) node (or device) that connects the terminal to a wireless network, and may also be referred to as a base station. For example, examples of some RAN nodes are: a continuously evolved NodeB (gNB), a transmission reception point (TRP), an evolved NodeB (eNB), a radio network controller (RNC), a NodeB (NB), a base station controller (BSC), a base transceiver station (BTS), a home base station (for example, a home evolved NodeB, or a home NodeB (HNB)), a baseband unit (BBU), a WI-FI access point (AP), a satellite in a satellite communication system, a radio controller in a cloud radio access network (CRAN) scenario, a wearable device, an uncrewed aerial vehicle, a device in Internet of vehicles (for example, a vehicle-to-everything (V2X) device), a communication device in device-to-device (D2D) communication, or the like.

In a possible implementation, the network device may include a central unit (CU) node, or a distributed unit (DU) node, or a RAN device including a CU node and a DU node. The RAN device including the CU node and the DU node splits protocol layers of an eNB in an LTE system. Functions of a part of protocol layers are centrally controlled by a CU, functions of a part of or all of remaining protocol layers are distributed in a DU, and the CU centrally controls the DU. In some deployment of the network device, the CU may be further split into a CU-control plane (CP), a CU-user plane (UP), and the like. In another possible implementation, the network device may alternatively be an antenna unit (RU), or the like. In still another possible implementation, the network device may alternatively be of an open radio access network (ORAN) architecture or the like. A specific type of the network device is not limited in this disclosure. For example, when the network device is of the ORAN architecture, the network device in embodiments of this disclosure may be an access network device in an ORAN, a module in the access network device, or the like. In an ORAN system, a CU may also be referred to as an open central unit (O-CU), a DU may also be referred to as an open distributed unit (O-DU), a CU-DU may also be referred to as an open central unit-distributed unit (O-CU-DU), a CU-UP may also be referred to as an open central unit-control plane (O-CU-UP), and an RU may also be referred to as an open antenna unit (O-RU). Optionally, Table 1 shows a correspondence between a network element in the ORAN system and a protocol layer function that can be implemented by the network element. Communication between the access network device and the terminal device complies with a specific protocol layer structure. Protocol layers may include a control plane protocol layer and a user plane protocol layer. The control plane protocol layer may include at least one of the following: an RRC layer, a Packet Data Convergence Protocol (PDCP) layer, a radio link control (RLC) layer, a media access control (MAC) layer, a physical (PHY) layer, or the like. The user plane protocol layer may include at least one of the following: a Service Data Adaptation Protocol (SDAP) layer, a PDCP layer, an RLC layer, a MAC layer, a physical layer, or the like.

TABLE 1
ORAN network element and corresponding protocol layer function

| ORAN network element | 3GPP protocol layer function |
|---|---|
| O-CU-CP | RRC + PDCP-C |
| O-CU-UP | SDAP + PDCP-U |
| O-DU | RLC + MAC + PHY-high |
| O-RU | PHY-low |

It should be noted that “sending” and “receiving” in embodiments of this disclosure represent signal transfer directions. For example, “sending information to a terminal” may be understood as a destination of the information being the terminal device. “Sending” may include direct sending through an air interface, or indirect sending by another unit or module through an air interface. “Receiving information from a network device” may be understood as a source of the information being the network device. “Receiving” may include direct receiving from the network device through an air interface, or indirect receiving from the network device from another unit or module through an air interface. “Sending” may alternatively be understood as “outputting” from a chip interface, and “receiving” may alternatively be understood as “inputting” into the chip interface.

In other words, sending and receiving may be performed between devices, for example, between the network device and the terminal device, or may be performed within a device, for example, sending or receiving is performed between components, modules, chips, software modules, or hardware modules within a device through a bus, a cable, or an interface.

It may be understood that necessary processing, such as coding and modulation, may be performed on the information between the source at which the information is sent and the destination, but the destination may understand valid information from the source. Similar descriptions in this disclosure may be understood similarly, and details are not described again.

In embodiments of this disclosure, “indication” may include a direct indication and an indirect indication, or may include an explicit indication and an implicit indication. Information indicated by a piece of information (for example, the following indication information) is referred to as to-be-indicated information. In a specific implementation process, the to-be-indicated information may be indicated in a plurality of manners, for example, but not limited to, directly indicating the to-be-indicated information, for example, the to-be-indicated information or an index of the to-be-indicated information. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, specific information may alternatively be indicated by using an arrangement sequence of pieces of information that are pre-agreed on (for example, predefined in a protocol), to reduce indication overheads to some extent. A specific indication manner is not limited in this disclosure. It may be understood that, for a sender of the indication information, the indication information may indicate to-be-indicated information, and for a receiver of the indication information, the indication information may be for determining to-be-indicated information.

I. For ease of understanding, the following describes in detail definitions of related terms in this disclosure.
1. RS in this Disclosure

RSs in this disclosure may include but are not limited to a demodulation RS (DMRS), a sounding RS (SRS), a CSI-RS, and the like. Specifically, the DMRS is used by a receiver for channel estimation and for demodulation of a physical channel. NR DMRS port resources are orthogonal, frequency domain resources of each port are evenly distributed, and resource densities between ports are the same. A base station may evaluate an uplink channel parameter based on the SRS. NR SRS port resources are orthogonal, frequency domain resources of each port are evenly distributed, and resource densities between ports are the same. The CSI-RS is used for CSI measurement and reporting of a channel quality indicator (CQI), a channel rank indicator (RI), and a precoding matrix indicator (PMI). NR CSI-RS port resources are orthogonal, frequency domain resources of each port are evenly distributed, and resource densities between ports are the same. In conclusion, in the current protocol, RS port resources are orthogonal, frequency domain resources of each port are evenly distributed, and resource densities between ports are the same. However, for ultra-high-dimensional receive/transmit antenna ports and a large number of transmission streams, numbers of ports for the SRS, the CSI-RS, and the DMRS surge (for example, increase by 10 to 30 times). If the even and dense RS design and CSI obtaining method in LTE and NR are still used, RS resource overheads are excessively large.

### 2. Feature of a First Resource Pattern or a Second Resource Pattern of an RS

Currently, a first RS resource pattern used for data transmission and CSI collection is designed, to support a multi-antenna MIMO technology based on ultra-high-dimensional receive/transmit antenna ports and ultra-wide bandwidth. Based on the design, RS resource overheads can be significantly reduced while achieving good performance. The first RS resource pattern (namely, the first resource pattern of the RS) or a second RS resource pattern (namely, the second resource pattern of the RS) is irregularly scattered across one or more of time domain, frequency domain, and spatial domain. For example, the RS is sent only through some transmit antenna ports, or each RS port occupies some resources in only frequency domain/time domain to send the RS. The first RS resource pattern or the second RS resource pattern may have different resource arrangement on different ports in frequency domain/time domain. This is conducive to reducing RS resource overheads.

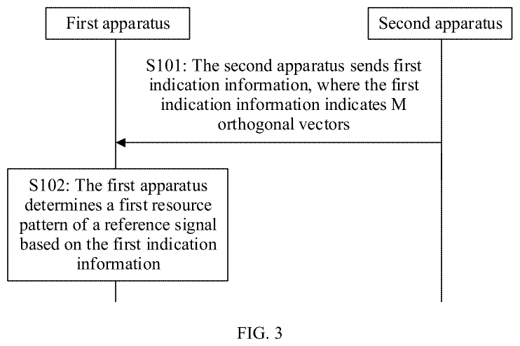

For example, FIG. 2 is a diagram of a first resource pattern of an RS according to this disclosure. Resources corresponding to a plurality of scattered points form the first resource pattern of the RS. In FIG. 2, a horizontal coordinate represents an antenna port, and a vertical coordinate represents a frequency domain resource. It can be seen that the first resource pattern of the RS is irregular. This irregularity makes it difficult for a resource pattern in the current protocol to correspond to the first resource pattern of the RS. Consequently, indication overheads of the resource pattern are large. For example, for the design of the RS (for example, a DMRS, an SRS, or a CSI-RS) in LTE and NR, port resources are orthogonal, frequency domain resources of each port are evenly distributed and dense, and frequency domain resource densities between ports are the same. Therefore, resource patterns of the evenly distributed RSs are also fixed. For example, for a DMRS, four patterns of the DMRS type 1 and type 2 are predefined in the protocol. A mapping relationship between a port index and a resource pattern is predefined in the protocol, and the resource pattern of the RS is indicated by indicating the port index. However, for an uneven resource pattern of the RS, a mapping relationship between a port index and the resource pattern cannot be predefined. Optionally, currently, the resource pattern of the RS may be indicated by a bitmap. For example, 1 bit indicates whether each candidate resource of the RS is a resource of the RS. If a value of the bit is 0, it indicates that the candidate resource is not a resource of the RS. If the value of the bit is 1, it indicates that the candidate resource is a resource of the RS. However, this indication manner causes large indication overheads. For example, for an SRS, it is assumed that a bandwidth resource of the RS includes 16*12 subcarriers, a number of transmit antenna ports is 32, and a number of resource locations of the RS is 16. In this case, a total number of resources of the SRS is 32*16*12=6144 bits, and the indication overheads are large.

II. Communication Method Provided in this Disclosure

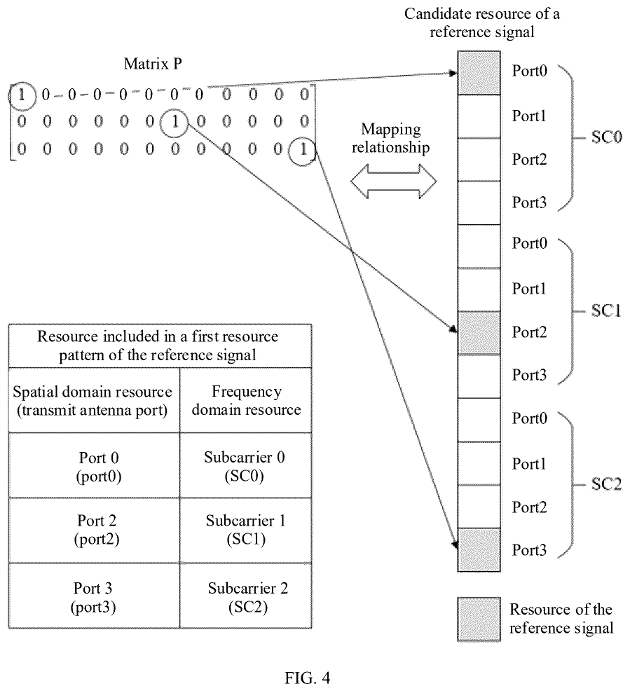

FIG. 3 is a schematic flowchart of a communication method according to this disclosure. The communication method is applied to the communication system shown in FIG. 1. For example, the communication method may be implemented through interaction between a first apparatus and a second apparatus. The first apparatus may be a terminal or an apparatus capable of implementing functions of the terminal, and the second apparatus may be a network device or an apparatus capable of implementing functions of the network device. The communication method includes the following steps.

S101: The second apparatus sends first indication information, where the first indication information indicates M orthogonal vectors, and correspondingly, the first apparatus receives the first indication information.

That the first indication information indicates the M orthogonal vectors may be indicating indexes and/or dimensions of the M orthogonal vectors. For example, the first indication information including the indexes and/or the dimensions of the M orthogonal vectors may specifically be that the first indication information includes the indexes and the dimensions of the M orthogonal vectors, or the first indication information may include only the indexes of the M orthogonal vectors. The indexes of the M orthogonal vectors respectively indicate different orthogonal vectors. For example, the M orthogonal vectors respectively correspond to M indexes (for example, the orthogonal vectors one-to-one correspond to the indexes). The dimension of the orthogonal vector is a number of elements (or components) included in the orthogonal vector, that is, a length of the orthogonal vector. For example, the dimensions of the M orthogonal vectors may be represented as M values, and each value is n1 (for example, each orthogonal vector includes n1 elements (or components)). Optionally, the dimensions of the M orthogonal vectors may be the same or different. Optionally, the first indication information includes a first moment, and the first moment corresponds to the indexes and/or the dimensions of the M orthogonal vectors. For example, the first moment is a specified moment, and the first moment may be a specified moment before a current moment. The first moment corresponds to the indexes and/or the dimensions of the M orthogonal vectors (if the second apparatus determines the indexes and/or the dimensions of the M orthogonal vectors at the first moment, the first moment corresponds to the indexes and/or the dimensions of the M orthogonal vectors). When the first indication information includes the first moment, it is equivalent to that the first indication information indicates the M orthogonal vectors corresponding to the first moment. In conclusion, the second apparatus may predefine a plurality of candidate orthogonal vectors or a method for generating a plurality of candidate orthogonal vectors, so that the first indication information indicates the indexes of the M orthogonal vectors in the plurality of candidate orthogonal vectors.

In a possible implementation, the first indication information sent by the second apparatus may be one piece of indication information, and the indication information includes a plurality of indexes and/or dimensions. Alternatively, the second apparatus may send a plurality of pieces of first indication information, and each piece of first indication information includes one or more indexes and/or dimensions.

In a possible implementation, the first indication information may be configured by RRC, or may be indicated by DCI or a MAC-CE. For example, it is assumed that the second apparatus is an O-CU-CP. In this case, the O-CU-CP may configure the first indication information based on the RRC. Alternatively, it is assumed that the second apparatus is an O-DU. In this case, the O-DU may indicate the first indication information to the terminal based on the MAC-CE. Alternatively, it is assumed that the second apparatus is an O-RU. In this case, the O-RU may indicate the first indication information to the terminal based on the DCI.

In a possible implementation, an update period of the first indication information is periodic, aperiodic, or semi-persistent. For example, if an RS is a periodic signal, the update period of the first indication information is periodic. If the RS is an aperiodic signal, the update period of the first indication information is aperiodic. If the RS is a semi-persistent signal, the update period of the first indication information is semi-persistent.

There is a mapping relationship between M orthogonal vectors and a first resource pattern of the RS. Specifically, the M orthogonal vectors belong to one or more orthogonal vector sets, a resource included in the first resource pattern of the RS belong to a candidate resource of the RS, and the one or more orthogonal vector sets correspond to the candidate resource of the RS. For example, a difference between one orthogonal vector set and a plurality of orthogonal vector sets lies in that one orthogonal vector set includes the M orthogonal vectors, and different orthogonal vectors in the M orthogonal vectors correspond to a same resource. For example, the M orthogonal vectors all correspond to a same resource. The plurality of orthogonal vector sets includes the M orthogonal vectors, a plurality of orthogonal vectors in the M orthogonal vectors correspond to different resources, and orthogonal vectors corresponding to a same resource form one orthogonal vector set. For example, it is assumed that s1 orthogonal vectors in the M orthogonal vectors correspond to a same resource. In this case, the s1 orthogonal vectors form an orthogonal vector set m1. It is assumed that s2 orthogonal vectors in the M orthogonal vectors correspond to a same resource (which is different from the resource corresponding to the s1 orthogonal vectors). In this case, the s2 orthogonal vectors form another orthogonal vector set m2, where s1+s2≤M.

There is a mapping relationship between the M orthogonal vectors in the orthogonal vector set and the first resource pattern, of the RS, of the candidate resource of the RS. In a possible implementation, the mapping relationship may specifically include the following cases.

Case 1: The M orthogonal vectors belong to one orthogonal vector set, all orthogonal vectors in the orthogonal vector set correspond to a same candidate resource of the RS, the candidate resource of the RS includes resources in one or more domains, and the one or more domains includes one or more of time domain, frequency domain, and spatial domain. The candidate resource of the RS is a set of resources that can be used to send or receive the RS.

For example, it is assumed that the M orthogonal vectors (for example, an orthogonal vector 1 to an orthogonal vector M) belong to one orthogonal vector set, and the orthogonal vector set includes orthogonal vectors in a DFT matrix, or a DCT matrix, or a Grassmannian manifold. In other words, the M orthogonal vectors are DFT vectors, or DCT vectors, or vectors in the Grassmannian manifold. The orthogonal vector set corresponds to the candidate resource (for example, resources in one or more of time domain, frequency domain, or spatial domain, where the resource is at a specific granularity) of the RS. For example, the orthogonal vector set corresponds to one or more of a candidate time domain resource, frequency domain resource, or spatial domain resource of the RS. The spatial domain resource includes one or more of a transmit antenna port, a receive antenna port, a horizontal antenna port, and a vertical antenna port. In other words, the orthogonal vector set corresponds to resources in different domains. A granularity of the time domain resource may be a radio frame, a subframe, a slot, a symbol, a mini-slot, a transmission time interval, or the like. A granularity of the frequency domain resource may be a subcarrier, a resource block (RB), a resource block group (RBG), a subband, a full band, or the like.

In a possible implementation, the resource included in the first resource pattern of the RS belongs to the candidate resource of the RS, in other words, the candidate resource of the RS includes the resource included in the first resource pattern of the RS, and there is a mapping relationship between a dimension of each of the M orthogonal vectors and a number of resources in the candidate resource of the RS. Specifically, the mapping relationship includes: if the candidate resource includes a resource in one domain, the dimension of each of the M orthogonal vectors is a number of resources in the resource in the domain; and if the candidate resource includes resources in a plurality of domains, the dimension of each of the M orthogonal vectors is a product of numbers of resources in the resources in the plurality of domains. For example, it is assumed that the candidate resource of the RS includes a frequency domain resource. In this case, the number of resources in the candidate resource of the RS is a number of resources in the frequency domain resource. It is assumed that the number of resources in the frequency domain resource of the RS is x₁. In this case, the dimension n₁ of each of the M orthogonal vectors is n₁=x₁. For another example, it is assumed that the candidate resource of the RS includes a frequency domain resource and a spatial domain resource. In this case, the number of resources in the candidate resource of the RS is a product of a number of resources in the frequency domain resource and a number of resources in the spatial domain resource. It is assumed that the number of resources in the frequency domain resource of the RS is x₁, and the number of resources in the spatial domain resource is x₂. In this case, the dimension n₁ of each of the M orthogonal vectors is n₁=x₁×x₂. Optionally, the mapping relationship further includes: If the candidate resource includes a resource in one domain, the dimension of each of the M orthogonal vectors is a multiple of a number of resources in the resource in the domain; and if the candidate resource includes resources in a plurality of domains, the dimension of each of the M orthogonal vectors is a multiple of a product of numbers of resources in the resources in the plurality of domains. For example, the dimension n₁ of each of the M orthogonal vectors is n₁=Ax₁, where A indicates a multiple.

Case 2: The M orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of different candidate resources of the RS, the candidate resource of the RS includes resources in one or more domains, and the one or more domains includes one or more of time domain, frequency domain, and spatial domain.

For example, it is assumed that the M orthogonal vectors (for example, an orthogonal vector 1 to an orthogonal vector M) belong to a plurality of orthogonal vector sets (which are assumed to be a first orthogonal vector set and a second orthogonal vector set), and each orthogonal vector set includes orthogonal vectors in a DFT matrix, or a DCT matrix, or a Grassmannian manifold. A difference between the case 2 and the case 1 lies in that the plurality of orthogonal vector sets respectively correspond to the candidate resource (for example, resources in one or more of time domain, frequency domain, and spatial domain) of the RS. For example, each orthogonal vector set corresponds to one or more of a candidate time domain resource, frequency domain resource, or spatial domain resource of the RS, and different orthogonal vector sets correspond to resources in different domains. A combination of parts of the candidate resources of the RS that correspond to the plurality of orthogonal vector sets corresponds to the entire candidate resource of the RS. For example, the first orthogonal vector set corresponds to the candidate time domain resource of the RS, and the second orthogonal vector set corresponds to a combination of the candidate frequency domain resource and spatial domain resource of the RS. In this case, the first orthogonal vector set and the second orthogonal vector set correspond to resources in different domains. A combination of the candidate time domain resource, of the RS, corresponding to the first orthogonal vector set and the candidate frequency domain resource and spatial domain resource, of the RS, corresponding to the second orthogonal vector set corresponds to the entire candidate resource of the RS.

In a possible implementation, resources included in a combination of candidate resources of the RS that correspond to the plurality of orthogonal vector sets include the first resource pattern of the RS. There is a mapping relationship between a dimension of each orthogonal vector in any one of the plurality of orthogonal vector sets and a number of resources in a candidate resource corresponding to the orthogonal vector set. The mapping relationship includes: If the candidate resource corresponding to the any orthogonal vector set includes a resource in one domain, the dimension of each orthogonal vector in the orthogonal vector set is a number of resources in the resource in the domain; and if the candidate resource corresponding to the any orthogonal vector set includes resources in a plurality of domains, the dimension of each orthogonal vector in the orthogonal vector set is a product of numbers of resources in the resources in the plurality of domains. For example, it is assumed that the first orthogonal vector set corresponds to a time domain resource of the RS, and a number of resources in the time domain resource is x₁. In this case, a dimension n₁ of each orthogonal vector in the first orthogonal vector set is n₁=x₁. It is assumed that the candidate resource, of the RS, corresponding to the second orthogonal vector set includes a frequency domain resource and a spatial domain resource. In this case, the number of resources in the candidate resource of the RS is a product of a number of resources in the frequency domain resource and a number of resources in the spatial domain resource. It is assumed that the number of resources in the frequency domain resource of the RS is x₂, and the number of resources in the spatial domain resource is x₃. In this case, a dimension n₂ of each orthogonal vector in the second orthogonal vector set is n₂=x₂×x₃. Optionally, the mapping relationship further includes: If the candidate resource corresponding to the any orthogonal vector set includes a resource in one domain, the dimension of each orthogonal vector in the orthogonal vector set is a multiple of a number of resources in the resource in the domain; and if the candidate resource corresponding to the any orthogonal vector set includes resources in a plurality of domains, the dimension of each orthogonal vector in the orthogonal vector set is a multiple of a product of numbers of resources in the resources in the plurality of domains. For example, the dimension n₂ of each orthogonal vector in the second orthogonal vector set is n₂=B(x₂×x₃), where B indicates a multiple.

S102: The first apparatus determines the first resource pattern of the RS based on the first indication information.

There is a mapping relationship between the M orthogonal vectors and the first resource pattern of the RS. The first apparatus may determine the first resource pattern of the RS based on the M orthogonal vectors indicated by the first indication information. For example, in this disclosure, a method for determining a first resource pattern of an RS based on one or more orthogonal vectors is predefined, and the determining method has different implementations in different cases.

1. In correspondence with the case 1 in S101, S102 includes the following implementations:

Implementation 1: The first resource pattern of the RS is a resource pattern formed by candidate resources corresponding to a group of linearly irrelevant row vectors of a first sub-unitary matrix. The first sub-unitary matrix is formed by arranging the M orthogonal vectors by column, and there is a one-to-one mapping relationship between the row vector of the first sub-unitary matrix and the candidate resource of the RS. In the implementation 1, that the first apparatus determines the first resource pattern of the RS based on the first indication information may specifically include the following procedure:

(1) The first apparatus arranges the M orthogonal vectors by column, to form the first sub-unitary matrix, and there is a one-to-one mapping relationship between the row vector of the first sub-unitary matrix and the candidate resource of the RS.

(2) The first apparatus selects a group of linearly irrelevant row vectors from the first sub-unitary matrix, and the resource pattern including the candidate resource corresponding to the group of linearly irrelevant row vectors is the first resource pattern of the RS.

The M orthogonal vectors indicated by the first indication information may be arranged by column, to form the first sub-unitary matrix F_{n*s}, where n indicates dimensions of the orthogonal vectors, and s indicates a number of indexes of the orthogonal vectors. Specifically, the M orthogonal vectors may be arranged by column in ascending or descending order of the indexes of the orthogonal vectors. For example, it is assumed that the indexes of the M orthogonal vectors are X₁-X_{M} (M is a positive integer greater than 1). If X₁<X₂< . . . <X_{M}, the M orthogonal vectors may be arranged by column in ascending order X₁-X_{M} of the indexes of the orthogonal vectors, to form F_{n*s}. There is a one-to-one mapping relationship between the row vector of the first sub-unitary matrix and the candidate resource of the RS. The mapping relationship may be configured, or indicated, or predefined in a protocol. For example, it is assumed that the candidate resource of the RS includes spatial domain resources (for example, transmit antenna ports 0 to 3) and frequency domain resources 0 to 3. In this case, a manner of combining the candidate resources of the RS may be traversing the transmit antenna ports 0 to 3 and then traversing the frequency domain resources 0 to 3, to obtain combinations of candidate resources: (antenna port 0, frequency domain resource 0), (antenna port 1, frequency domain resource 0), (antenna port 2, frequency domain resource 0), (antenna port 3, frequency domain resource 0), (antenna port 0, frequency domain resource 1), (antenna port 1, frequency domain resource 1), (antenna port 2, frequency domain resource 1), (antenna port 3, frequency domain resource 1), (antenna port 0, frequency domain resource 2), (antenna port 1, frequency domain resource 2), (antenna port 2, frequency domain resource 2), (antenna port 3, frequency domain resource 2), (antenna port 0, frequency domain resource 3), (antenna port 1, frequency domain resource 3), (antenna port 2, frequency domain resource 3), and (antenna port 3, frequency domain resource 3). There is a one-to-one mapping relationship between the row vector of the first sub-unitary matrix and the candidate resource. In this example, each row vector of the first sub-unitary matrix may correspond to a combination of a spatial domain resource and a frequency domain resource. The mapping relationship may be pre-configured by the first apparatus (for example, it is preset that an index of each row vector corresponds to an index of one transmit antenna port and an index of one frequency domain resource), or may be indicated by the second apparatus to the first apparatus (for example, RRC configuration indicates that an index of each row vector corresponds to an index of one transmit antenna port and an index of one frequency domain resource), or may be predefined in a protocol (for example, it is predefined in a protocol that an index of each row vector corresponds to an index of one transmit antenna port and an index of one frequency domain resource). This is not limited in this disclosure.

The first apparatus may select a group of linearly irrelevant row vectors from the first sub-unitary matrix F_{n*s}. It is assumed that the group of linearly irrelevant row vectors includes t linearly irrelevant rows. A value of t may be pre-configured by the first apparatus (for example, the value of t is predefined in a protocol), or may be indicated by the second apparatus to the first apparatus (for example, RRC configuration indicates the value of t). This is not limited in this disclosure. There is a plurality of methods for the first apparatus to select t linearly irrelevant rows from the first sub-unitary matrix F_{n*s}, for example, QR factorization with column pivoting (QR factorization with column pivoting) and a machine learning method. For example, if the first apparatus selects the t linearly irrelevant rows from the first sub-unitary matrix F_{n*s} by using the QR factorization method, QR factorization may be performed according to a formula (1):

$${F}_{n * s}^{H} {P}_{t * n}^{T} = {Q}_{s * s} {R}_{s * t} \qquad ( 1 )$$

F_{n*s} indicates the first sub-unitary matrix,

$${F}_{n * s}^{H}$$

indicates a conjugate transpose matrix of the first sub-unitary matrix, P_{t*n} indicates a permutation matrix, a value of each element in the permutation matrix is 0 or 1, t column indexes corresponding to t elements whose values are 1 correspond to the t linearly irrelevant row vectors in the first sub-unitary matrix F_{n*s},

$${P}_{t * n}^{T}$$

indicates a transpose matrix of the permutation matrix, Q_{s*s} indicates an orthogonal matrix, R_{s*t} indicates a triangular matrix, t indicates a number of linearly irrelevant row vectors, n indicates the dimensions of the orthogonal vectors, and s indicates the number of indexes of the orthogonal vectors. The t column indexes corresponding to the elements with values being “1” in the permutation matrix P_{t*n} indicate the t linearly irrelevant row vectors in the first sub-unitary matrix F_{n*s}, and the candidate resource, of the RS, corresponding to indexes of the t linearly irrelevant row vectors forms the first resource pattern of the RS.

Optionally, QR factorization with column pivoting may be implemented by using a Givens transformation method, a Householder transformation method, a Gram-Schmidt orthogonalization method, or the like. This is not limited in this disclosure. Optionally, a unique matrix P_{t*n} may be obtained through QR factorization according to a predefined rule.

In a possible implementation, the predefined rule needs to meet the following condition: Rows included in the first sub-unitary matrix or a matrix obtained by performing linear transformation on the first sub-unitary matrix are arranged according to a rule of 2-norm of row vectors the rows (for example, in descending order of the 2-norm of the rows), and first t row indexes after arrangement are the column indexes corresponding to the elements with values being “1” in the matrix P.

In a possible implementation, the predefined rule needs to meet the following condition: Columns included in the first sub-unitary matrix or a matrix obtained by performing linear transformation on the first sub-unitary matrix are arranged according to a rule of 2-norm of the columns (for example, in descending order of the 2-norm of the columns), and first t columns indexes after arrangement are row indexes corresponding to the elements with values being “1” in the matrix P.

In a possible implementation, the predefined rule needs to meet the following condition: Modulus values of diagonal elements in R_{s*t} are arranged in descending order.

In a possible implementation, the predefined rule needs to meet the following condition: A plurality of matrices P_{t*n} are obtained through QR factorization, the plurality of matrices Pten correspond to a plurality of matrices R_{s*t}, and a matrix P corresponding to a matrix R_{s*t} with a maximum sum of modulus values of diagonal elements in the matrices R_{s*t} is selected. Optionally, when there are a plurality of R matrices having a same sum of modulus values of diagonal elements, a matrix P with a minimum sum of row indexes of elements with values being “1” in a plurality of P matrices corresponding to the plurality of R matrices is selected.

In a possible implementation, the predefined rule may meet one or more of the foregoing conditions.

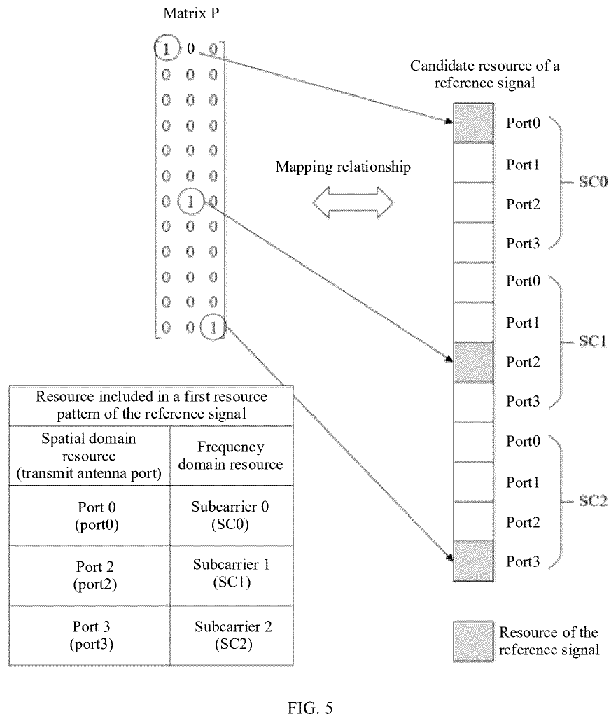

For example, FIG. 4 is a diagram of determining a first resource pattern of an RS based on a candidate resource corresponding to a group of linearly irrelevant row vectors according to this disclosure. It is assumed that the number t of linearly irrelevant rows is 3, the dimensions n of the orthogonal vectors are 12, and the matrix P is shown in FIG. 4. It is assumed that the candidate resource of the RS includes a spatial domain resource and a frequency domain resource, for example, includes transmit antenna ports: port0 to port3, and frequency domain locations (for example, frequency domain subcarriers): SC0 to SC2, a manner of combining the candidate resources of the RS may be traversing the transmit antenna ports and then traversing the frequency domain resources. A combination of the transmit antenna ports and the frequency domain locations includes the following 12 groups of resources: (SC0, Port0), (SC0, Port1), (SC0, Port2), (SC0, Port3), (SC1, Port0), (SC1, Port1), (SC1, Port2), (SC1, Port3), (SC2, Port0), (SC2, Port1), (SC2, Port2), and (SC2, Port3). The candidate resource of the RS includes the 12 groups of resources, and there is a one-to-one mapping relationship between columns of the matrix P and the 12 groups of resources, as shown in FIG. 4. The first apparatus may determine, based on the matrix P, that column indexes whose value is 1 in the matrix are 1, 7, and 12. Because the columns of the matrix P one-to-one correspond to (SC0, Port0), (SC0, Port1), (SC0, Port2), (SC0, Port3), (SC1, Port0), (SC1, Port1), (SC1, Port2), (SC1, Port3), (SC2, Port0), (SC2, Port1), (SC2, Port2) and (SC2, Port3), the resource of the RS corresponds to resources in gray in FIG. 4, that is, (SC0, Port0), (SC1, Port2), and (SC2, Port3). The first resource pattern of the RS is shown in one column in FIG. 4.

Implementation 2: The first resource pattern of the RS is a resource pattern formed by candidate resources corresponding to a group of linearly irrelevant column vectors of a first sub-unitary matrix. The first sub-unitary matrix is formed by arranging the M orthogonal vectors by row, and there is a one-to-one mapping relationship between the column vector of the first sub-unitary matrix and the candidate resource of the RS. In the implementation 2, that the first apparatus determines the first resource pattern of the RS based on the first indication information may specifically include the following procedure:

(1) The first apparatus arranges the M orthogonal vectors by row, to form the first sub-unitary matrix, and there is a one-to-one mapping relationship between the column vector of the first sub-unitary matrix and the candidate resource of the RS.

(2) The first apparatus selects a group of linearly irrelevant column vectors from the first sub-unitary matrix, and a resource pattern formed by candidate resources corresponding to the group of linearly irrelevant column vectors is the first resource pattern of the RS.

For a specific procedure of the implementation 2, refer to corresponding descriptions in the implementation 1. The following mainly describes a difference between the implementation 2 and the implementation 1. In the implementation 2, the M orthogonal vectors indicated by the first indication information are arranged by row, to form the first sub-unitary matrix F_{s*n}, where s indicates a number of indexes of the orthogonal vectors, and n indicates dimensions of the orthogonal vectors. Similarly, the M orthogonal vectors may be arranged by row in ascending or descending order of the indexes of the orthogonal vectors, and there is a one-to-one mapping relationship between the column vector of the obtained first sub-unitary matrix and the candidate resource of the RS. A specific example is similar to the example in the implementation 1. For details, refer to the foregoing descriptions. Details are not described herein again.

The difference between the implementation 2 and the implementation 1 lies in that when the M orthogonal vectors are arranged by row, the first apparatus selects a group of linearly irrelevant column vectors from the first sub-unitary matrix F_{s*n}, and the group of linearly irrelevant column vectors includes t linearly irrelevant columns. There is a plurality of methods for the first apparatus to select t linearly irrelevant columns from the first sub-unitary matrix F_{s*n}, for example, QR factorization with column pivoting (QR factorization with column pivoting) and a machine learning method. For example, if the first apparatus selects the t linearly irrelevant columns from the first sub-unitary matrix F_{s*n} by using the QR factorization method, QR factorization may be performed according to a formula (2):

$${F}_{s * n} {P}_{n * t} = {Q}_{s * s} {R}_{s * t} \qquad ( 2 )$$

F_{s*n} indicates the first sub-unitary matrix, P_{n*t} indicates a permutation matrix, a value of each element in the permutation matrix is 0 or 1, t row indexes corresponding to t elements whose values are 1 correspond to the t linearly irrelevant column vectors in the first sub-unitary matrix F_{s*n}, Q_{s*s} an orthogonal matrix, R_{s*t} indicates a triangular matrix, t indicates a number of linearly irrelevant column vectors, n indicates the dimensions of the orthogonal vectors, and s indicates the number of indexes of the orthogonal vectors. For details about QR factorization and a predefined rule, refer to corresponding descriptions in the implementation 1. Details are not described herein again.

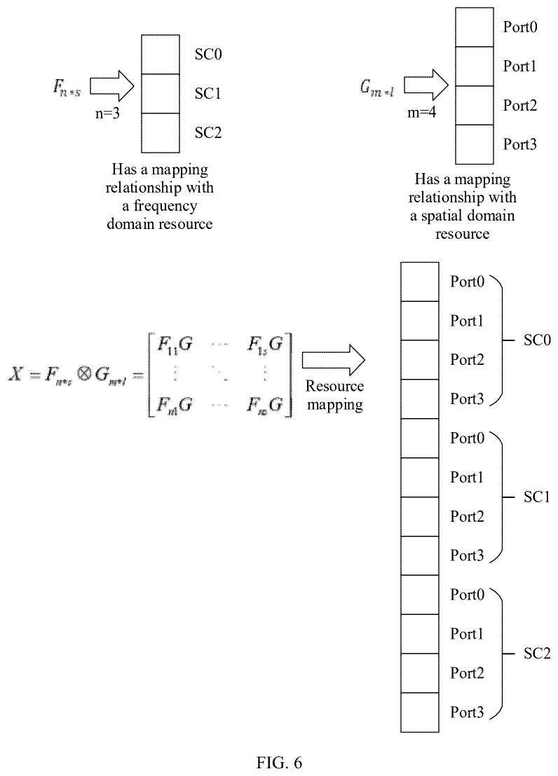

For example, FIG. 5 is a diagram of determining a first resource pattern of an RS based on a candidate resource corresponding to a group of linearly irrelevant column vectors according to this disclosure. It is assumed that the number t of linearly irrelevant columns is 3, the dimensions n of the orthogonal vectors are 12, and the matrix P is shown in FIG. 5. Same assumption as that in FIG. 4 is made on the candidate resource of the RS, that is, the candidate resource of the RS includes 12 groups of resources, and there is a one-to-one mapping relationship between rows of the matrix P and the 12 groups of resources, as shown in FIG. 5. The first apparatus may determine, based on the matrix P, that row indexes whose value is 1 in the matrix P are 1, 7, and 12. Because the rows of the matrix P one-to-one correspond to (SC0, Port0), (SC0, Port1), (SC0, Port2), (SC0, Port3), (SC1, Port0), (SC1, Port1), (SC1, Port2), (SC1, Port3), (SC2, Port0), (SC2, Port1), (SC2, Port2) and (SC2, Port3), the resource of the RS corresponds to resources in gray in FIG. 5, that is, (SC0, Port0), (SC1, Port2), and (SC2, Port3). The first resource pattern of the RS is shown in one column in FIG. 5. In conclusion, the same first resource pattern of the RS may be obtained by using the implementation 1 or the implementation 2. After receiving the first indication information, the first apparatus may obtain the same first resource pattern of the RS even if different processing manners are used. Therefore, the first resource pattern is indicated by the orthogonal vectors, to reduce indication overheads.

2. In correspondence with the case 2 in S101, S102 includes the following implementations:

Implementation 3: The first resource pattern of the RS is a resource pattern formed by candidate resources corresponding to a group of linearly irrelevant row vectors of a second sub-unitary matrix. There is a one-to-one mapping relationship between the row vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by column, and there is a one-to-one mapping relationship between a row vector of the first sub-unitary matrix and a candidate resource, of the RS, corresponding to the orthogonal vector set. In the implementation 3, that the first apparatus determines the first resource pattern of the RS based on the first indication information may specifically include the following procedure:

(1) The first apparatus arranges, according to a predefined arrangement rule, the plurality of orthogonal vector sets to which the M orthogonal vectors belong, to separately form the plurality of first sub-unitary matrices by column, and there is a one-to-one mapping relationship between a row vector of a first sub-unitary matrix and a candidate resource, of the RS, corresponding to one orthogonal vector set.

(2) The first apparatus performs Kronecker product processing on the plurality of first sub-unitary matrices, to obtain one second sub-unitary matrix, and there is a one-to-one mapping relationship between a row vector of the second sub-unitary matrix and the resources included in the combination of the candidate resources of the RS that correspond to the plurality of orthogonal vector sets.

(3) The first apparatus selects a group of linearly irrelevant row vectors from the second sub-unitary matrix, and a resource pattern formed by candidate resources corresponding to the group of linearly irrelevant row vectors is the first resource pattern of the RS.

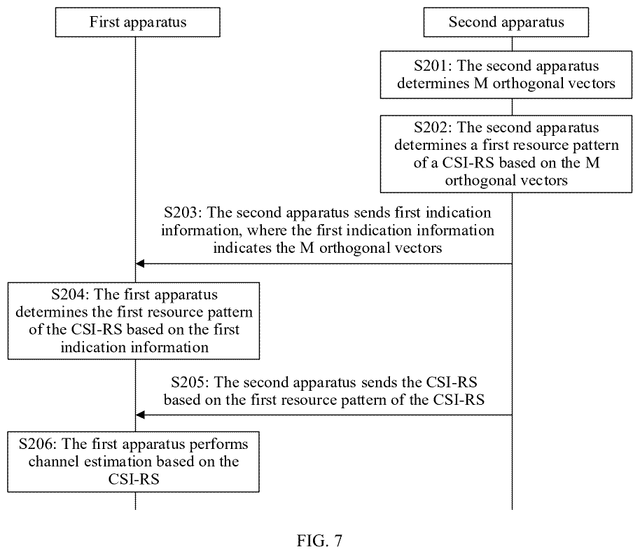

For a specific procedure of the implementation 3, refer to corresponding descriptions in the implementation 1. The following mainly describes a difference between the implementation 3 and the implementation 1. In the implementation 3, the M orthogonal vectors indicated by the first indication information belong to the plurality of orthogonal vector sets, and an orthogonal vector in each orthogonal vector set may be arranged by column, to form one first sub-unitary matrix. The plurality of orthogonal vector sets form the plurality of first sub-unitary matrices. There is a one-to-one mapping relationship between the row vector of each first sub-unitary matrix and the candidate resource, of the RS, corresponding to the corresponding orthogonal vector set. A specific example is similar to the example in the implementation 1. For details, refer to the foregoing descriptions. For example, it is assumed that the M orthogonal vectors belong to two orthogonal vector sets (for example, a first orthogonal vector set and a second orthogonal vector set), s orthogonal vectors in the first orthogonal vector set are arranged by column, to form one first sub-unitary matrix F_{n*s}, and/orthogonal vectors in the second orthogonal vector set are arranged by column, to form the other first sub-unitary matrix G_{m*l}. It is assumed that F_{n*s} corresponds to n candidate frequency domain resources, and G_{m*l} corresponds to m candidate transmit antenna port resources. For example, a mapping relationship between the plurality of first sub-unitary matrices and the candidate resources of the RS is shown in FIG. 6. The mapping relationship in FIG. 6 may be pre-configured by the first apparatus, or may be indicated by the second apparatus to the first apparatus, or may be predefined in a protocol. For example descriptions, refer to corresponding descriptions in the implementation 1. For example, the matrix F_{n*s} corresponds to n=3 candidate frequency domain resources: SC0, SC1, and SC2. A specific mapping relationship is shown in FIG. 6. The matrix G_{m*l} corresponds to m=4 candidate transmit antenna port resources: Port0, Port1, Port2, and Port3. A specific mapping relationship is shown in FIG. 6.

A difference between the implementation 3 and the implementation 1 lies in that the first apparatus performs Kronecker product processing on the plurality of first sub-unitary matrices, to obtain one second sub-unitary matrix, and there is a one-to-one mapping relationship between the row vector of the second sub-unitary matrix and the resources included in the combination of the candidate resources of the RS that correspond to the plurality of orthogonal vector sets. For example, the first apparatus may perform Kronecker product processing on the matrix F_{n*s} and the matrix G_{m*l} according to a formula (3), to obtain one second sub-unitary matrix X.

$$X = {F}_{n * s} ⊗ {G}_{m * l} = [ \begin{matrix}{F}_{11} G & … & {F}_{1 s} G \\ ⋮ & ⋱ & ⋮ \\ {F}_{n 1} G & … & {F}_{ns} G\end{matrix} ] \qquad ( 3 )$$

F_{n*s} includes s orthogonal vectors and corresponds to n candidate frequency domain resources, G_{m*l} includes/orthogonal vectors and corresponds to m candidate transmit antenna port resources, and s+l=M. For example, there is a one-to-one mapping relationship between a row vector of the second sub-unitary matrix X and the resources included in the combination of the candidate resources of the RS that correspond to the plurality of orthogonal vector sets. In other words, there is a one-to-one mapping relationship between the second sub-unitary matrix X and 12 groups of resources included in a combination of n=3 candidate frequency domain resources and m=4 candidate transmit antenna port resources, as shown in FIG. 6.

The implementation 3 is similar to the implementation 1. The first apparatus selects a group of linearly irrelevant row vectors from the second sub-unitary matrix X. It is assumed that the group of linearly irrelevant row vectors includes t linearly irrelevant rows. For example, the first apparatus may select the t linearly irrelevant rows from the second sub-unitary matrix X by using the QR factorization method, and QR factorization is performed according to a formula (4):

$${( {F}_{n * s} ⊗ {G}_{m * l} )}^{H} {P}_{t * ( n * m )}^{T} = {Q}_{( s * l ) * ( s * l )} {R}_{( s * l ) * t} \qquad ( 4 )$$

F_{n*s}⊗G_{m*l} indicates the second sub-unitary matrix, (F_{n*s}⊗G_{m*l}) indicates a conjugate transpose matrix of the second sub-unitary matrix, P_{t*(n*m)} indicates a permutation matrix (a value of each element in the permutation matrix is 0 or 1, and t column indexes corresponding to t elements whose values are 1 corresponds to the t linearly irrelevant row vectors in the second sub-unitary matrix),

$${P}_{t * ( n * m )}^{T}$$

indicates a transpose matrix of the permutation matrix, Q_{(s*l)*(s*l)} indicates an orthogonal matrix, R_{(s*l)*t} indicates a triangular matrix, s indicates a number of orthogonal vectors in the first orthogonal vector set, n indicates a candidate frequency domain resource corresponding to the first orthogonal vector set, l indicates a number of orthogonal vectors in the second orthogonal vector set, m indicates a candidate transmit antenna port resource corresponding to the second orthogonal vector set, and s+l=M. The column indexes of the elements with values being “1” in the matrix P_{t*(n*m)} indicate the t linearly irrelevant row vectors in the second sub-unitary matrix, and the candidate resource, of the RS, corresponding to indexes of the t linearly irrelevant row vectors forms the first resource pattern of the RS. For specific descriptions about QR factorization and a predefined rule, refer to corresponding descriptions in the implementation 1.

For example, the implementation 3 is similar to FIG. 4, the first apparatus may select t=3 linearly irrelevant row vectors from the second sub-unitary matrix, and the dimensions of the orthogonal vectors are n*m=12. The matrix P is shown in FIG. 4. Based on the descriptions in FIG. 4, resources corresponding to column indexes whose values are 1 in the matrix P are resources of the RS, and the first resource pattern of the RS is shown in one column in FIG. 4.

Implementation 4: The first resource pattern of the RS is a resource pattern formed by candidate resources corresponding to a group of linearly irrelevant column vectors of a second sub-unitary matrix. There is a one-to-one mapping relationship between the column vector of the second sub-unitary matrix and the resources included in the combination of the candidate resources of the RS that correspond to the plurality of orthogonal vector sets, and the second sub-unitary matrix is a Kronecker product of a plurality of first sub-unitary matrices. One first sub-unitary matrix is formed by arranging an orthogonal vector included in one orthogonal vector set by row, and there is a one-to-one mapping relationship between a column vector of the first sub-unitary matrix and a candidate resource, of the RS, corresponding to the orthogonal vector set. In the implementation 4, that the first apparatus determines the first resource pattern of the RS based on the first indication information may specifically include the following procedure:

(1) The first apparatus arranges, according to a predefined arrangement rule, the plurality of orthogonal vector sets to which the M orthogonal vectors belong, to separately form the plurality of first sub-unitary matrices by row, and there is a one-to-one mapping relationship between a column vector of a first sub-unitary matrix and a candidate resource, of the RS, corresponding to one orthogonal vector set.

(2) The first apparatus performs Kronecker product processing on the plurality of first sub-unitary matrices, to obtain one second sub-unitary matrix, and there is a one-to-one mapping relationship between a column vector of the second sub-unitary matrix and the resources included in the combination of the candidate resources of the RS that correspond to the plurality of orthogonal vector sets.

(3) The first apparatus selects a group of linearly irrelevant column vectors from the second sub-unitary matrix, and a resource pattern formed by candidate resources corresponding to the group of linearly irrelevant column vectors is the first resource pattern of the RS.

For a specific procedure of the implementation 4, refer to corresponding descriptions in the implementation 2 and the implementation 3. The following mainly describes a difference between the implementation 4 and the implementation 2 and the implementation 3. In the implementation 4, the M orthogonal vectors indicated by the first indication information belong to the plurality of orthogonal vector sets, and an orthogonal vector in each orthogonal vector set may be arranged by row, to form one first sub-unitary matrix. The plurality of orthogonal vector sets forms the plurality of first sub-unitary matrices. There is a one-to-one mapping relationship between the column vector of each first sub-unitary matrix and the candidate resource, of the RS, corresponding to the corresponding orthogonal vector set. A specific example is similar to the example in the implementation 2. For details, refer to the foregoing descriptions. For example, it is assumed that the M orthogonal vectors belong to two orthogonal vector sets (for example, a first orthogonal vector set and a second orthogonal vector set), orthogonal vectors in the first orthogonal vector set are arranged by row, to form one first sub-unitary matrix F_{s*n}, and orthogonal vectors in the second orthogonal vector set are arranged by column, to form the other first sub-unitary matrix G_{l*m}. It is assumed that F_{s*n} corresponds to n candidate frequency domain resources, and G_{l*m} corresponds to m candidate transmit antenna port resources. A specific mapping relationship is similar to that in FIG. 6.

A difference between the implementation 4 and the implementation 3 is that when the first apparatus performs Kronecker product processing on the plurality of first sub-unitary matrices to obtain the second sub-unitary matrix, subscripts of the matrices are different. For example, the first apparatus may perform Kronecker product processing on the matrix F_{s*n} and the matrix G_{l*m} according to a formula (5), to obtain one second sub-unitary matrix X′.

$${X}^{′} = {F}_{s * n} ⊗ {G}_{l * m} = [ \begin{matrix}{F}_{11} G & … & {F}_{s 1} G \\ ⋮ & ⋱ & ⋮ \\ {F}_{1 n} G & … & {F}_{sn} G\end{matrix} ] \qquad ( 5 )$$

F_{s*n} includes s orthogonal vectors and corresponds to n candidate frequency domain resources, G_{l*m} includes/orthogonal vectors and corresponds to m candidate transmit antenna port resources, and s+l=M. For example, there is a one-to-one mapping relationship between a row vector of the second sub-unitary matrix X′ and the resources included in the combination of the candidate resources of the RS that correspond to the plurality of orthogonal vector sets. In other words, there is a one-to-one mapping relationship between the second sub-unitary matrix X′ and 12 groups of resources included in a combination of n=3 candidate frequency domain resources and m=4 candidate transmit antenna port resources. A specific mapping relationship is similar to that in FIG. 6.

The implementation 4 is similar to the implementation 2. The first apparatus selects a group of linearly irrelevant column vectors from the second sub-unitary matrix X′. It is assumed that the group of linearly irrelevant column vectors includes t linearly irrelevant columns. For example, the first apparatus may select the t linearly irrelevant columns from the second sub-unitary matrix X′ by using the QR factorization method, and QR factorization is performed according to a formula (6):

$$( {F}_{s * n} ⊗ {G}_{l * m} ) {P}_{( n * m ) * t} = {Q}_{( s * l ) * ( s * l )} {R}_{( s * l ) * t} \qquad ( 6 )$$

F_{n*s} ⊗G_{m*l} indicates the second sub-unitary matrix, P_{(n*m)*t} indicates a permutation matrix (a value of each element in the permutation matrix is 0 or 1, and t row indexes corresponding to t elements whose values are 1 corresponds to the t linearly irrelevant column vectors in the second sub-unitary matrix), Q_{(s*l)*(s*l)} indicates an orthogonal matrix, R_{(s*l)*t} indicates a triangular matrix, s indicates a number of orthogonal vectors in the first orthogonal vector set, n indicates a candidate frequency domain resource corresponding to the first orthogonal vector set, l indicates a number of orthogonal vectors in the second orthogonal vector set, m indicates a candidate transmit antenna port resource corresponding to the second orthogonal vector set, and s+l=M. The row indexes of the elements with values being “1” in the matrix P_{(n*m)*t} indicates the t linearly irrelevant column vectors in the second sub-unitary matrix, and the candidate resource, of the RS, corresponding to indexes of the t linearly irrelevant column vectors forms the first resource pattern of the RS. For specific descriptions about QR factorization and a predefined rule, refer to corresponding descriptions in the implementation 1.

For example, the implementation 4 is similar to FIG. 5, the first apparatus may select t=3 linearly irrelevant column vectors from the second sub-unitary matrix, and the dimensions of the orthogonal vectors are n*m=12. The matrix P is shown in FIG. 5. Based on the descriptions in FIG. 5, resources corresponding to row indexes whose values are 1 in the matrix P are resources of the RS, and the first resource pattern of the RS is shown in one column in FIG. 5.

In a possible implementation, the methods for determining the first resource pattern of the RS based on the indicated one or more orthogonal vectors in the implementation 1 to the implementation 4 may be separately performed. For example, the implementation 1 to the implementation 4 may not be embedded in the method procedure shown in FIG. 3, and may be directly performed. For example, when the first apparatus and the second apparatus know the first indication information (or know the one or more orthogonal vectors), the resource pattern of the RS may be directly determined based on the method shown in the implementation 1 to the implementation 4.

In this embodiment, the first apparatus may receive the first indication information, where the first indication information may indicate the M orthogonal vectors, and there is a mapping relationship between the M orthogonal vectors and the first resource pattern of the RS. In other words, the first apparatus may derive the first resource pattern of the RS based on the M orthogonal vectors indicated by the first indication information. Compared with a direct indication of the resource pattern of the RS, the indication of the M orthogonal vectors can significantly reduce indication overheads.

III. The following describes in detail specific procedures in which the communication method in this disclosure is applied to different scenarios.

An example in which an RS is a CSI-RS, an SRS, or a DMRS is used. The following describes the communication method in this disclosure in detail by using the following examples. A first apparatus may be a terminal or an apparatus capable of implementing functions of the terminal, and a second apparatus may be a network device or an apparatus capable of implementing functions of the network device.

Example 1: The second apparatus sends first indication information, and the first apparatus determines a resource pattern of the CSI-RS after receiving the first indication information.

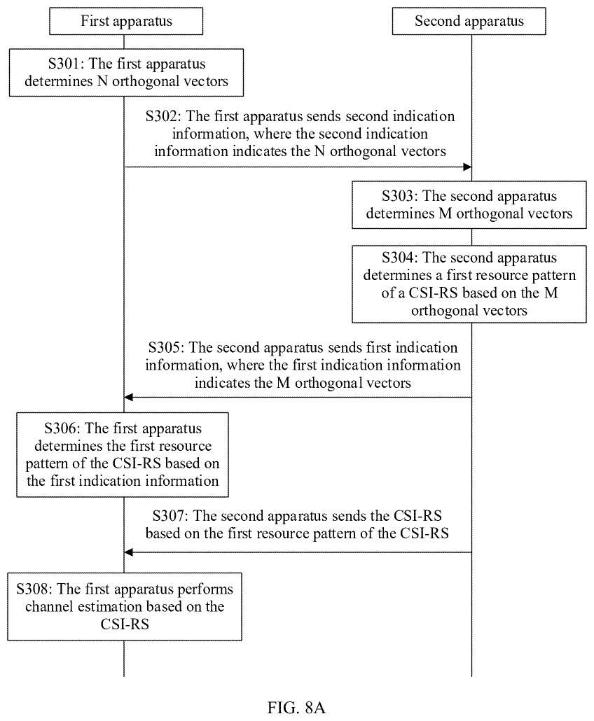

For example, FIG. 7 is a schematic flowchart of determining a resource pattern of a CSI-RS according to this disclosure. The following steps are included.

S201: A second apparatus determines M orthogonal vectors.

In a possible implementation, it is assumed that a plurality of candidate orthogonal vectors is predefined or a method for generating a plurality of candidate orthogonal vectors is predefined. The second apparatus may select the M orthogonal vectors from the plurality of candidate orthogonal vectors based on a channel characteristic. For example, dimensions of the plurality of candidate orthogonal vectors may be different, and the plurality of candidate orthogonal vectors may belong to a same DFT matrix, or DCT matrix, or Grassmannian manifold, or may belong to different DFT matrices, or DCT matrices, or Grassmannian manifolds. Different DFT matrices, or DCT matrices, or Grassmannian manifolds mean that orthogonal vectors in the DFT matrices, or DCT matrices, or Grassmannian manifolds have different dimensions. The M orthogonal vectors are main M basis vectors that form a channel space.

S202: The second apparatus determines a first resource pattern of a CSI-RS based on the M orthogonal vectors.

For a specific implementation of S202, refer to corresponding descriptions in S102. Details are not described herein again.

S203: The second apparatus sends first indication information, where the first indication information indicates M orthogonal vectors, and correspondingly, the first apparatus receives the first indication information.

S204: The first apparatus determines the first resource pattern of the CSI-RS based on the first indication information.

For specific implementations of S203 and S204, refer to corresponding descriptions in S101 and S102. Details are not described herein again.

S205: The second apparatus sends the CSI-RS based on the first resource pattern of the CSI-RS, and correspondingly, the first apparatus receives the CSI-RS based on the first resource pattern of the CSI-RS.

S206: The first apparatus performs channel estimation based on the CSI-RS. For a specific channel estimation method, refer to descriptions in an existing protocol standard. This is not limited in this disclosure.

In the example 1, the second apparatus determines and sends the M orthogonal vectors, and indicates the resource pattern of the RS based on the M orthogonal vectors. This helps reduce indication overheads of the RS. In addition, the first apparatus may determine the first resource pattern of the CSI-RS based on the M orthogonal vectors. This helps accurately receive the CSI-RS and perform channel estimation.

Example 2: The second apparatus determines first indication information, the first apparatus determines and sends second indication information, and the first apparatus and the second apparatus separately determine resource patterns of the CSI-RS.

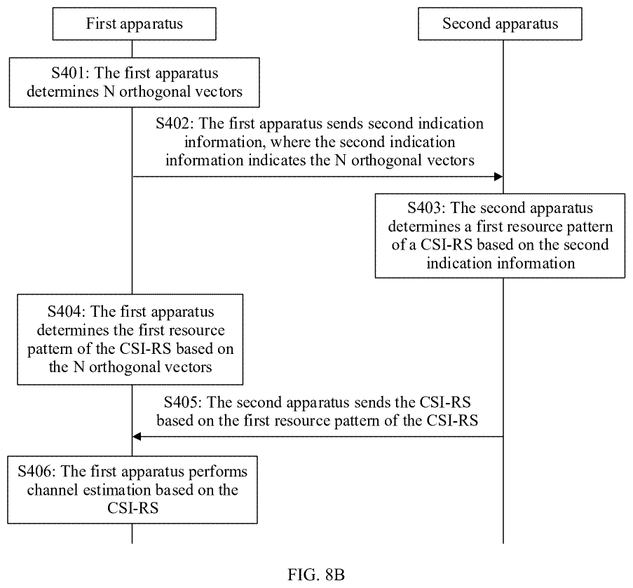

For example, FIG. 8A is another schematic flowchart of determining a resource pattern of a CSI-RS according to this disclosure. The following steps are included.

S301: A first apparatus determines N orthogonal vectors.

There is a mapping relationship between the N orthogonal vectors and a second resource pattern of the RS. Specifically, similar to M orthogonal vectors, the N orthogonal vectors determined by the first apparatus belong to one or more orthogonal vector sets, and a resource included in the second resource pattern of the RS belong to a candidate resource of the RS. The one or more orthogonal vector sets correspond to the candidate resource of the RS, and there is a mapping relationship between the N orthogonal vectors in the orthogonal vector set and the second resource pattern, of the RS, of the candidate resource of the RS. In a possible implementation, the mapping relationship may specifically include the following cases:

Case 1: The N orthogonal vectors belong to one orthogonal vector set, all orthogonal vectors in the orthogonal vector set correspond to a same candidate resource of the RS, and the candidate resource of the RS includes resources in one or more of time domain, frequency domain, and spatial domain.

Case 2: The N orthogonal vectors belong to a plurality of orthogonal vector sets, all orthogonal vectors included in each orthogonal vector set correspond to a same candidate resource of the RS, different orthogonal vector sets correspond to different candidate resources of the RS, the plurality of orthogonal vector sets correspond to resources included in a combination of a plurality of candidate resources of the RS, and the candidate resource of the RS includes resources in one or more of time domain, frequency domain, and spatial domain.

For specific implementations of the case 1 and the case 2, refer to descriptions of the case 1 and the case 2 in S101. Details are not described herein again.

S302: The first apparatus sends second indication information, where the second indication information indicates the N orthogonal vectors, and correspondingly, a second apparatus receives the second indication information.

That the second indication information indicates the N orthogonal vectors may be indicating indexes and/or dimensions of the N orthogonal vectors. For example, the second indication information including the indexes and/or the dimensions of the N orthogonal vectors may specifically be that the second indication information includes the indexes and the dimensions of the N orthogonal vectors, or the second indication information may include only the indexes of the N orthogonal vectors. The indexes of the N orthogonal vectors respectively indicate different orthogonal vectors. For example, the N orthogonal vectors respectively correspond to N indexes (for example, the orthogonal vectors one-to-one correspond to the indexes). The dimensions of the N orthogonal vectors are also referred to as lengths of the N orthogonal vectors. For example, the lengths of the N orthogonal vectors each are represented as n2. Optionally, the second indication information includes a second moment, and the second moment corresponds to indexes and/or dimensions of the N orthogonal vectors. For example, the second moment is a specified moment, and the second moment may be a specified moment before a current moment. The second moment corresponds to the indexes and/or the dimensions of the N orthogonal vectors (if the first apparatus determines the indexes and/or the dimensions of the N orthogonal vectors at the second moment, the second moment corresponds to the indexes and/or the dimensions of the N orthogonal vectors). When the second indication information includes the second moment, it is equivalent to that the second indication information indicates the N orthogonal vectors corresponding to the second moment. In conclusion, the first apparatus may predefine a plurality of candidate orthogonal vectors or a method for generating a plurality of candidate orthogonal vectors, so that the second indication information indicates the indexes of the N orthogonal vectors in the plurality of candidate orthogonal vectors.

In a possible implementation, the second indication information sent by the first apparatus may be one piece of indication information, and the indication information includes a plurality of indexes and/or dimensions. Alternatively, the first apparatus may send a plurality of pieces of second indication information, and each piece of second indication information includes one or more indexes and/or dimensions.

In a possible implementation, the second indication information may be configured by RRC, or may be indicated by uplink control information (UCI) or a MAC-CE.

S303: The second apparatus determines M orthogonal vectors.

In a possible implementation, the second apparatus may determine the M orthogonal vectors based on a channel characteristic, and then determine a resource pattern of the RS based on the M orthogonal vectors. Specifically, the second apparatus may determine indexes and/or dimensions of the M orthogonal vectors, and then determine the resource pattern of the RS based on the indexes and/or the dimensions of the M orthogonal vectors. For a specific implementation, refer to corresponding descriptions in S102.

In a possible implementation, the second apparatus may determine the M orthogonal vectors based on the N orthogonal vectors. In this case, the N orthogonal vectors determined by the first apparatus are the same as the M orthogonal vectors (N=M).

In a possible implementation, the second apparatus may determine M′ orthogonal vectors based on the channel characteristic, and then determine the M orthogonal vectors based on the N orthogonal vectors. The M orthogonal vectors may include some orthogonal vectors in the M′ orthogonal vectors or the N orthogonal vectors, but are not all the same as the M′ orthogonal vectors or the N orthogonal vectors.

In a possible implementation, for the second apparatus determining the resource pattern of the RS based on the M orthogonal vectors, refer to corresponding descriptions in S101 and S102. For example, it is assumed that the second apparatus presets indexes of a plurality of orthogonal vectors, and selects indexes of the M orthogonal vectors from the indexes based on the channel characteristic. The M orthogonal vectors are main M basis vectors that form a channel space.

S304: The second apparatus determines a first resource pattern of the CSI-RS based on the M orthogonal vectors.

S305: The second apparatus sends first indication information, where the first indication information indicates the M orthogonal vectors, and correspondingly, the first apparatus receives the first indication information.

S306: The first apparatus determines the first resource pattern of the CSI-RS based on the first indication information.

For a specific implementation of S306, refer to corresponding descriptions in S102. For example, the first apparatus arranges the M orthogonal vectors by column, to form a first sub-unitary matrix, and there is a one-to-one mapping relationship between a row vector of the first sub-unitary matrix and the candidate resource of the RS. The first apparatus selects a group of linearly irrelevant row vectors from the first sub-unitary matrix, and a resource pattern formed by candidate resources corresponding to the group of linearly irrelevant row vectors is the first resource pattern of the CSI-RS. A specific procedure is not described herein.

In the procedure: S305 and S306 shown in FIG. 8A, the second apparatus sends the first indication information to the first apparatus, where the M orthogonal vectors indicated by the first indication information may be the same as or different from the N orthogonal vectors determined by the first apparatus. However, the second apparatus may send the first indication information to the first apparatus, to indicate the M orthogonal vectors, so that both the first apparatus and the second apparatus determine the first resource pattern of the CSI-RS based on the M orthogonal vectors.

S307: The second apparatus sends the CSI-RS based on the first resource pattern of the CSI-RS, and correspondingly, the first apparatus receives the CSI-RS based on the first resource pattern of the CSI-RS.

S308: The first apparatus performs channel estimation based on the CSI-RS. For a specific channel estimation method, refer to descriptions in an existing protocol standard. This is not limited in this disclosure.

For another example, FIG. 8B is still another schematic flowchart of determining a resource pattern of a CSI-RS according to this disclosure. The following steps are included.

S401: A first apparatus determines N orthogonal vectors.

S402: The first apparatus sends second indication information, where the second indication information indicates the N orthogonal vectors, and correspondingly, a second apparatus receives the second indication information.

For specific implementations of S401 and S402, refer to corresponding descriptions in S301 and S302. Details are not described herein again.

S403: The second apparatus determines a first resource pattern of a CSI-RS based on the second indication information.

The second apparatus may directly determine the first resource pattern of the CSI-RS based on the N orthogonal vectors indicated by the second indication information.

S404: The first apparatus determines the first resource pattern of the CSI-RS based on the N orthogonal vectors.

For a specific implementation of S404, refer to corresponding descriptions in S102. Details are not described herein again.

S405: The second apparatus sends the CSI-RS based on the first resource pattern of the CSI-RS, and correspondingly, the first apparatus receives the CSI-RS based on the first resource pattern of the CSI-RS.

S406: The first apparatus performs channel estimation based on the CSI-RS. For a specific channel estimation method, refer to descriptions in an existing protocol standard. This is not limited in this disclosure.

For another example, FIG. 8C and FIG. 8D are yet another schematic flowchart of determining a resource pattern of a CSI-RS according to this disclosure. The following steps are included.

S501: A first apparatus determines N orthogonal vectors.

S502: The first apparatus sends second indication information, where the second indication information indicates the N orthogonal vectors, and correspondingly, a second apparatus receives the second indication information.

S503: The second apparatus determines M orthogonal vectors.

For specific implementations of S501 to S503, refer to corresponding descriptions in S301 to S303. Details are not described herein again.

S504a: If the M orthogonal vectors are the same as the N orthogonal vectors, the second apparatus does not need to send first indication information.

In a possible implementation, the M orthogonal vectors are the same as the N orthogonal vectors. For example, indexes and dimensions of the M orthogonal vectors are the same as indexes and dimensions of the N orthogonal vectors; or indexes of the M orthogonal vectors are the same as indexes of the N orthogonal vectors. Therefore, the first apparatus has determined the N orthogonal vectors that are the same as the M orthogonal vectors, and a second resource pattern, of an RS, corresponding to the N orthogonal vectors is the same as a first resource pattern, of the RS, corresponding to the M orthogonal vectors. In this case, the second apparatus does not need to send the first indication information to the first apparatus.

S504b: If the M orthogonal vectors are different from the N orthogonal vectors, the second apparatus sends the first indication information, where the first indication information indicates the M orthogonal vectors, and correspondingly, the first apparatus receives the first indication information.

In a possible implementation, the M orthogonal vectors are different from the N orthogonal vectors. For example, indexes and dimensions of the M orthogonal vectors are different from indexes and dimensions of the N orthogonal vectors; or indexes of the M orthogonal vectors are different from indexes of the N orthogonal vectors; or dimensions of the M orthogonal vectors are different from dimensions of the N orthogonal vectors. Therefore, a second resource pattern, of an RS, corresponding to the N orthogonal vectors is different from a first resource pattern, of the RS, corresponding to the M orthogonal vectors. In this case, the second apparatus needs to send the first indication information to the first apparatus, to indicate the first resource pattern for sending the RS.

In a possible implementation, that the second apparatus sends the first indication information may be specifically directly sending the first indication information, or sending a first moment, where the first moment corresponds to indexes and/or dimensions of the M orthogonal vectors. For example, the first moment is a moment before the second apparatus sends the first indication information. At the first moment, the first apparatus may record the corresponding M orthogonal vectors. Optionally, the second apparatus may pre-indicate, based on RRC configuration, that the first apparatus needs to record, for a time period, indexes and/or dimensions of orthogonal vectors and a resource pattern, of the RS, corresponding to the orthogonal vectors. Optionally, after recording the indexes and/or the dimensions of the orthogonal vectors and the resource pattern, of the RS, corresponding to the orthogonal vectors, the first apparatus may send one or more orthogonal vectors corresponding to the first moment to the second apparatus. The second apparatus determines, based on an orthogonal vector corresponding to a current moment, that the orthogonal vector corresponding to the current moment is the same as the orthogonal vector corresponding to the first moment. In this case, the second apparatus may send the indexes and/or the dimensions of the orthogonal vectors corresponding to the first moment to the first apparatus, so that the first apparatus determines the first resource pattern of the RS based on the indexes and/or the dimensions of the orthogonal vectors corresponding to the first moment.

S505a: If the first apparatus does not receive the first indication information, the first apparatus determines the first resource pattern of the CSI-RS based on the second indication information.

For example, the first apparatus does not receive the first indication information in a time period after sending the second indication information. The first apparatus may determine that the N orthogonal vectors are the same as the M orthogonal vectors determined by the second apparatus. In this case, the resource pattern, of the RS, corresponding to the N orthogonal vectors is the same as the resource pattern, of the RS, corresponding to the M orthogonal vectors. The first apparatus may determine the resource pattern, of the RS, corresponding to the N orthogonal vectors as the first resource pattern of the CSI-RS.

For a specific implementation in which the first apparatus determines the first resource pattern of the CSI-RS based on the second indication information, refer to corresponding descriptions in S102. For example, the first apparatus arranges the M orthogonal vectors by column, to form a first sub-unitary matrix, and there is a one-to-one mapping relationship between a row vector of the first sub-unitary matrix and a candidate resource of the RS. The first apparatus selects a group of linearly irrelevant row vectors from the first sub-unitary matrix, and a resource pattern formed by candidate resources corresponding to the group of linearly irrelevant row vectors is the first resource pattern of the CSI-RS. A specific procedure is not described herein.

S505b: If the first apparatus receives the first indication information, the first apparatus determines the first resource pattern of the CSI-RS based on the first indication information.

For a specific implementation in which the first apparatus determines the first resource pattern of the CSI-RS based on the first indication information, refer to corresponding descriptions in S102. Details are not described herein again.

Optionally, S504a and S505a and S504b and S505b are steps in different implementations, and steps in one implementation are performed based on a different situation.

S506: The second apparatus sends the CSI-RS based on the first resource pattern of the CSI-RS, and correspondingly, the first apparatus receives the CSI-RS based on the first resource pattern of the CSI-RS.

S507: The first apparatus performs channel estimation based on the CSI-RS. For a specific channel estimation method, refer to descriptions in an existing protocol standard. This is not limited in this disclosure.

In the example 2, the first apparatus may determine the N orthogonal vectors. If the N orthogonal vectors are the same as the M orthogonal vectors determined by the second apparatus, the second apparatus does not need to indicate the orthogonal vectors to the first apparatus. This may further reduce indication overheads of the RS.

Example 3: The second apparatus determines and sends first indication information based on the RS SRS, and the first apparatus determines a resource pattern of the SRS after receiving the first indication information.

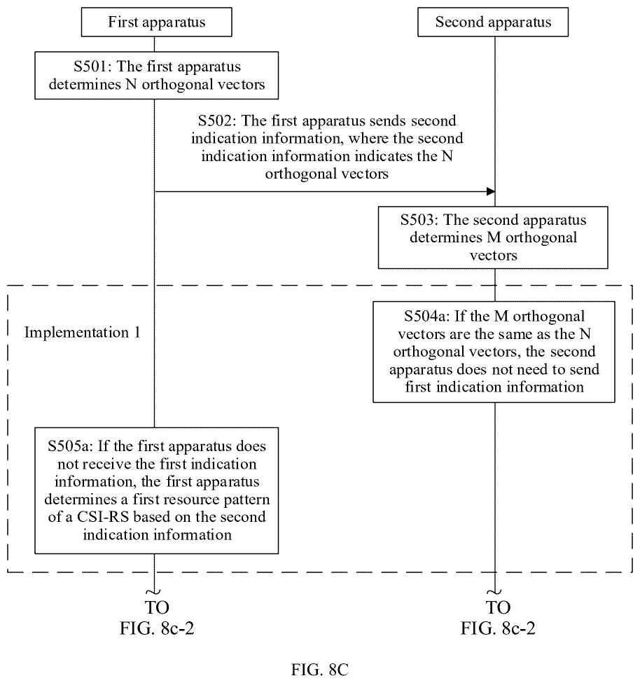

For example, FIG. 9 is a schematic flowchart of determining a resource pattern of an SRS according to this disclosure. The following steps are included.

S601: A second apparatus determines M orthogonal vectors.

S602: The second apparatus determines a first resource pattern of an SRS based on the M orthogonal vectors.

For specific implementations of S601 and S602, refer to corresponding descriptions in S201 and S202. Details are not described herein again.

S603: The second apparatus sends first indication information, where the first indication information indicates the M orthogonal vectors, and correspondingly, a first apparatus receives the first indication information.

S604: The first apparatus determines the first resource pattern of the SRS based on the first indication information.

For specific implementations of S603 and S604, refer to corresponding descriptions in S101 and S102. Details are not described herein again.

S605: The first apparatus sends the SRS based on the first resource pattern of the SRS, and correspondingly, the second apparatus receives the SRS based on the first resource pattern of the SRS.

S606: The second apparatus performs channel estimation based on the SRS.

For specific implementations of S605 and S606, refer to corresponding descriptions in S205 and S206. Details are not described herein again.

In the example 3, a specific implementation and beneficial effect are similar to those in the example 1, to help reduce indication overheads of the RS. A difference lies in that the RS in the example 3 is an SRS.

Example 4: The second apparatus determines and sends first indication information based on the RS DMRS, and the first apparatus determines a resource pattern of the DMRS after receiving the first indication information.

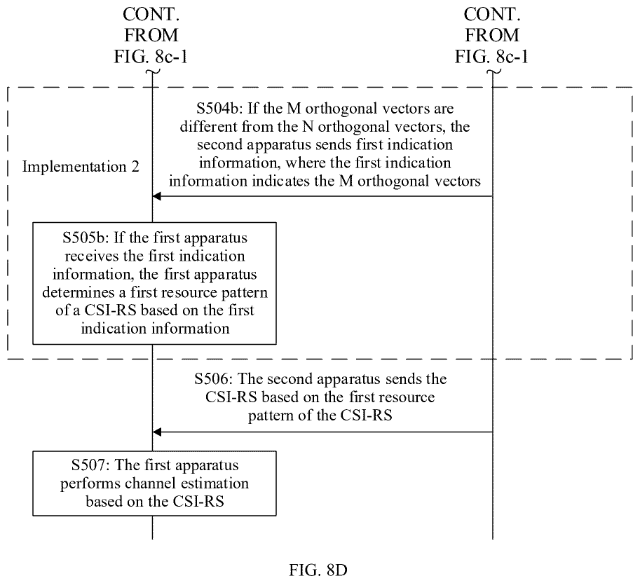

For example, FIG. 10 is a schematic flowchart of determining a resource pattern of a DMRS according to this disclosure. The following steps are included.

S701: A second apparatus determines M orthogonal vectors.

S702: The second apparatus determines a first resource pattern of a DMRS based on the M orthogonal vectors.

For specific implementations of S701 and S702, refer to corresponding descriptions in S201 and S202. Details are not described herein again.

S703: The second apparatus sends first indication information, where the first indication information indicates the M orthogonal vectors, and correspondingly, a first apparatus receives the first indication information.

S704: The first apparatus determines the first resource pattern of the DMRS based on the first indication information.

For specific implementations of S703 and S704, refer to corresponding descriptions in S101 and S102. Details are not described herein again.

S705: The second apparatus sends the DMRS based on the first resource pattern of the DMRS, and correspondingly, the first apparatus receives the DMRS based on the first resource pattern of the DMRS.

S706: The first apparatus performs channel estimation based on the DMRS.

For specific implementations of S705 and S706, refer to corresponding descriptions in S205 and S206. Details are not described herein again.

In the example 4, a specific implementation and beneficial effect are similar to those in the example 1, to help reduce indication overheads of the RS. A difference lies in that the RS in the example 4 is a DMRS.

IV. A resource pattern of an RS is indicated on a bandwidth part.

In this disclosure, it is assumed that a bandwidth part (BWP) may be further divided into one or more bandwidth resources, and third indication information is defined, to indicate the one or more bandwidth resources. The one or more bandwidth resources are associated with a first resource pattern. For example, the one or more bandwidth resources are a minimum frequency domain granularity corresponding to a resource pattern of an RS. The one or more bandwidth resources are consecutive bandwidth resources in the BWP. For example, the third indication information is indicated by the second apparatus to the first apparatus, so that the second apparatus can indicate the resource pattern of the RS to the first apparatus by using fewer indication overheads.

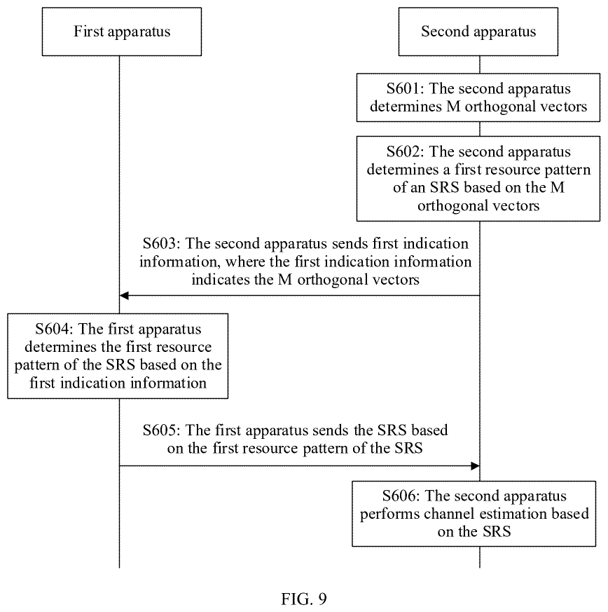

In a possible implementation, the plurality of bandwidth resources include a first bandwidth resource and a second bandwidth resource, and a resource pattern corresponding to the second bandwidth resource is the same as a resource pattern corresponding to the first bandwidth resource; or first indication information corresponding to the second bandwidth resource is the same as first indication information corresponding to the first bandwidth resource; or one or more orthogonal vectors corresponding to the second bandwidth resource are the same as one or more orthogonal vectors corresponding to the first bandwidth resource. For example, FIG. 11 is a diagram in which a plurality of bandwidth resources corresponds to a same resource pattern according to this disclosure. In FIG. 11, a bandwidth resource 1 may be considered as the first bandwidth resource, and a bandwidth resource 2 may be considered as the second bandwidth resource. The bandwidth resource 1 and the bandwidth resource 2 may correspond to a same resource pattern (for example, both correspond to the first resource pattern of the RS). Optionally, it may be considered that the bandwidth resource 1 and the bandwidth resource 2 correspond to same first indication information, or the bandwidth resource 1 and the bandwidth resource 2 correspond to same M orthogonal vectors.

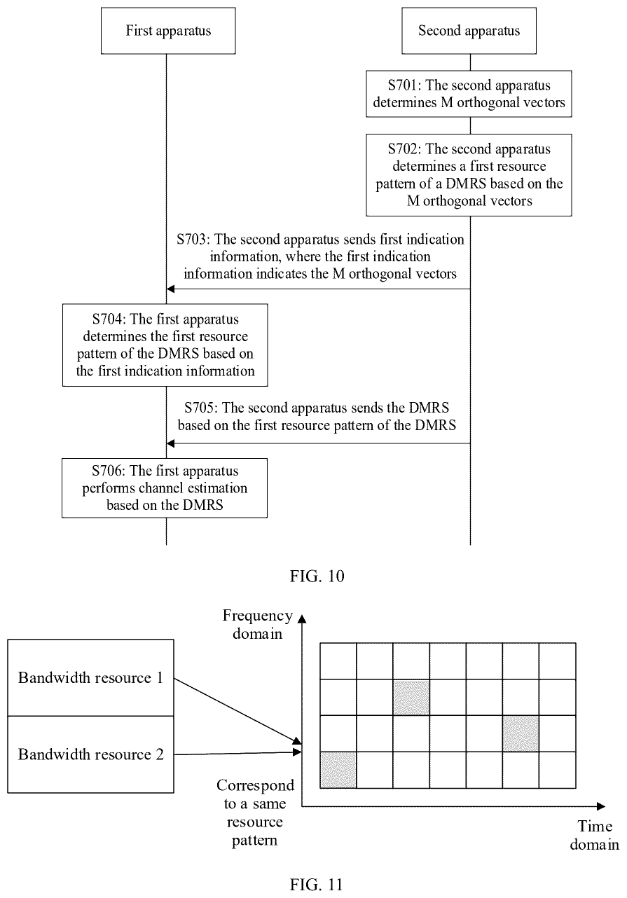

In a possible implementation, the plurality of bandwidth resources include a first bandwidth resource and a second bandwidth resource, and a resource pattern corresponding to the second bandwidth resource is different from a resource pattern corresponding to the first bandwidth resource; or first indication information corresponding to the second bandwidth resource is different from first indication information corresponding to the first bandwidth resource; or one or more orthogonal vectors corresponding to the second bandwidth resource are different from one or more orthogonal vectors corresponding to the first bandwidth resource. For example, FIG. 12 is a diagram in which a plurality of bandwidth resources corresponds to different resource patterns according to this disclosure. In FIG. 12, a bandwidth resource 1 may be considered as the first bandwidth resource, and a bandwidth resource 2 may be considered as the second bandwidth resource. The bandwidth resource 1 and the bandwidth resource 2 may correspond to different resource patterns (for example, the bandwidth resource 1 corresponds to the first resource pattern of the RS, and the bandwidth resource 2 corresponds to a third resource pattern of the RS, where the first resource pattern is different from the third resource pattern). Optionally, it may be considered that the bandwidth resource 1 and the bandwidth resource 2 correspond to different first indication information, or the bandwidth resource 1 and the bandwidth resource 2 correspond to different orthogonal vectors.

In a possible implementation, the resource pattern of the RS may be obtained by combining resource patterns corresponding to bandwidth resources indicated by a plurality of pieces of third indication information. As shown in FIG. 11 and FIG. 12, resource patterns corresponding to different bandwidth resources may be the same or may be different. In this implementation, the resource pattern of the RS is a resource pattern obtained by combining resource patterns corresponding to the bandwidth resources 1 and 2.

In a possible implementation, it is assumed that the BWP may be divided into N_{UnitBWP} bandwidth resources, and one or more bandwidth resources indicated by the third indication information belong to N_{UnitBWP} the bandwidth resources. For example, indexes of the N_{UnitBWP} bandwidth resources are #1, #2, . . . , #N_{UnitBWP}. The N_{UnitBWP} bandwidth resources include the first bandwidth resource and the second bandwidth resource described in the foregoing embodiments.

In a possible implementation, a relationship between a resource pattern, of the RS, corresponding to the one or more bandwidth resources indicated by the third indication information and the resource pattern, of the RS, indicated by the first indication information is as follows:

Relationship 1: A resource pattern, of the RS, corresponding to one bandwidth resource indicated by the third indication information is the resource pattern, of the RS, indicated by the first indication information.

Relationship 2: Resource patterns, of the RS, separately corresponding to a plurality of bandwidth resources indicated by the third indication information each are the resource pattern, of the RS, indicated by the first indication information. For example, the bandwidth resources 1 and 2 shown in FIG. 11 are the plurality of bandwidth resources, and correspond to a same resource pattern of the RS (the resource pattern, of the RS, indicated by the first indication information).

Optionally, if there are a plurality of pieces of first indication information (the plurality of pieces of first indication information indicate different resource patterns of the RS), a plurality of pieces of third indication information are needed, to indicate corresponding bandwidth resources.

In a possible implementation, a relationship between a resource pattern, of the RS, corresponding to the one or more bandwidth resources indicated by the third indication information and the resource pattern, of the RS, indicated by the first indication information is as follows: If a plurality of bandwidth resources indicated by one piece of third indication information separately correspond to different resource patterns of the RS, different resource patterns, of the RS, corresponding to the plurality of bandwidth resources indicated by the third indication information correspond to resource patterns, of the RS, indicated by different first indication information. For example, the bandwidth resources 1 and 2 shown in FIG. 12 are the plurality of bandwidth resources, and the bandwidth resources 1 and 2 may be the plurality of bandwidth resources indicated by one piece of third indication information. The bandwidth resource 1 and the bandwidth resource 2 correspond to different resource patterns of the RS, and the bandwidth resource 1 and the bandwidth resource 2 correspond to resource patterns, of the RS, indicated by different first indication information.

In a possible implementation, a value of N_{UnitBWP} may be obtained according to a formula (7). For example, a number N_{UnitBWP} of bandwidth resources included in the BWP is shown in the formula (7):

$${N}_{UnitBWP} = ⌈ ( {N}_{BWP , i}^{size} + ( {N}_{BWP , i}^{start} mod P ) ) / P ⌉ \qquad ( 7 )$$

$${N}_{BWP , i}^{size}$$

indicates a size of an i^{th} BWP configured by the second apparatus for the first apparatus,

$${N}_{BWP , i}^{start}$$

indicates an index of a start RB (that is, an example frequency domain resource unit) of an i^{th} bandwidth resource, P indicates a size of a bandwidth resource, and may be represented by a number of RBs included in the BWP, P is a positive integer, mod indicates a modulo operation, and ┌ ┐ indicates a rounding-up operation.

Optionally, a size of an initial bandwidth resource and a size of a last bandwidth resource in the BWP are affected by a start location and an end location of the BWP, and may not be P. For example, in the i^{th} BWP, a size of an initial bandwidth resource is represented as

$${UnitBWP}_{0}^{size} , and {UnitBWP}_{0}^{size}$$

meets a formula (8):

$${UnitBWP}_{0}^{size} = P - {N}_{BWP , i}^{start} mod P \qquad ( 8 )$$

When

$$( {N}_{BWP , i}^{start} + {N}_{BWP , i}^{size} ) mod P > 0 ,$$

a size of a last bandwidth resource is represented as

$${UnitBWP}_{last}^{size} , and {UnitBWP}_{last}^{size}$$

meets a formula (9):

$${UnitBWP}_{last}^{size} = \frac{{N}_{BWP , i}^{start} + {N}_{BWP , i}^{size}}{P} \qquad ( 9 )$$

When

$$( {N}_{BWP , i}^{start} + {N}_{BWP , i}^{size} ) mod P = 0 ,$$

the size of the last bandwidth resource is P.

In a possible implementation, fourth indication information is further defined in this disclosure, and indicates one or more bandwidth resources, and the one or more bandwidth resources are associated with the second resource pattern. For example, the one or more bandwidth resources are a minimum frequency domain granularity corresponding to the resource pattern of the RS. The one or more bandwidth resources are consecutive bandwidth resources in the BWP. The first apparatus determines the second resource pattern as a resource pattern, of the RS, corresponding to the N orthogonal vectors. For example, the fourth indication information is indicated by the first apparatus to the second apparatus, so that the first apparatus can indicate the resource pattern of the RS to the second apparatus by using fewer indication overheads.

For example, the plurality of bandwidth resources include a third bandwidth resource and a fourth bandwidth resource, and a resource pattern corresponding to the fourth bandwidth resource is the same as a resource pattern corresponding to the third bandwidth resource; or second indication information corresponding to the fourth bandwidth resource is the same as second indication information corresponding to the third bandwidth resource; or one or more orthogonal vectors corresponding to the fourth bandwidth resource are the same as one or more orthogonal vectors corresponding to the third bandwidth resource. For another example, a resource pattern corresponding to the fourth bandwidth resource is different from a resource pattern corresponding to the third bandwidth resource; or second indication information corresponding to the fourth bandwidth resource is different from second indication information corresponding to the third bandwidth resource; or one or more orthogonal vectors corresponding to the fourth bandwidth resource are different from one or more orthogonal vectors corresponding to the third bandwidth resource. For specific implementations of the two examples, refer to corresponding descriptions in FIG. 11 and FIG. 12. A difference lies in that the third bandwidth resource and the fourth bandwidth resource are associated with the second indication information or the N orthogonal vectors corresponding to the second indication information.

In a possible implementation, the third indication information and the fourth indication information may be further applied to the procedures shown in FIG. 3 and FIG. 7 to FIG. 10. For example, when the third indication information is applied to the procedure shown in FIG. 3, the second apparatus may simultaneously send the first indication information and the third indication information, or may send the third indication information after sending the first indication information. Correspondingly, the first apparatus receives the third indication information, where the third indication information indicates one or more bandwidth resources, and the one or more bandwidth resources are associated with the first resource pattern. For another example, when the third indication information and the fourth indication information are applied to the procedures shown in FIG. 8A to FIG. 8C and FIG. 8D, the first apparatus may simultaneously send the second indication information and the fourth indication information, or may send the fourth indication information after sending the second indication information. Correspondingly, the second apparatus receives the fourth indication information, where the fourth indication information indicates one or more bandwidth resources, and the one or more bandwidth resources are associated with the second resource pattern. If the M orthogonal vectors are different from the N orthogonal vectors, the second apparatus may simultaneously send the first indication information and the third indication information, or may send the third indication information after sending the first indication information. Correspondingly, the first apparatus receives the third indication information, where the third indication information indicates one or more bandwidth resources, and the one or more bandwidth resources are associated with the first resource pattern.

In this embodiment, it is assumed that the BWP is further divided into one or more bandwidth resources, and the plurality of bandwidth resources may correspond to a same resource pattern. This may further reduce indication overheads of the resource pattern of the RS.

V. The following analyzes performance of the communication method provided in this disclosure.

For example, Table 2 is a schematic table of indication overheads of an indication manner using a bitmap or an indication manner using first indication information. In Table 2, for example, the RS is an SRS. It is assumed that the RS indicates that bandwidth is 16*12 subcarriers, a number of transmit antenna ports is 32, and a number of RS locations is 16.

TABLE 2
Schematic table of indication overheads of an indication manner using
a bitmap or an indication manner using first indication information

| Indication | | | | |
|---|---|---|---|---|
| manner | Length of | Number of orthogonal | Indication | |
| method | orthogonal vector(n) | vectors | overhead | |
| First | A number of | A number of | 4 * 8 bits + 4 * 5 | 1X |
| indication | subcarriers is 192 | orthogonal vectors for | bits = 52 bits | |
| information | (Number of | frequency domain is 4 | | |
| (indicating an | subcarriers = 192) | (Number of orthogonal | | |
| index of an | A number of | vectors for frequency | | |
| orthogonal | transmit antenna | domain = 4) | | |
| vector) | ports is 32 | A number of | | |
| Indicate | (Number of Tx | orthogonal vectors for | | |
| orthogonal | ports(UE) = 32) | spatial domain is 4 | | |
| vector indexes | | (Number of orthogonal | | |
| | | vectors for spatial | | |
| | | domain = 4) | | |
| Bitmap | | | 32 * 16 * 12 = | 118X |
| bitmap | | | 6144 bits | |

It can be seen that, in comparison with the indication manner using a bitmap, in this disclosure, the M orthogonal vectors are indicated, to significantly reduce indication overheads (reduce by 118 times).

For another example, Table 3 is another schematic table of indication overheads of an indication manner using a bitmap or an indication manner using first indication information. In Table 3, for example, the RS is a CSI-RS. It is assumed that the RS indicates that bandwidth is 16*12 subcarriers, a number of transmit antenna ports is 1024, and a number of RS locations is 16.

TABLE 3
Another schematic table of indication overheads of an indication manner
using a bitmap or an indication manner using first indication information

| Indication | Length of | | | |
|---|---|---|---|---|
| manner | orthogonal | | Indication | |
| method | vector(n) | Number of orthogonal vectors | overhead | |
| First | A number of | A number of orthogonal | 4 * 8 bits + 4 * | |
| indication | subcarriers is 192 | vectors for frequency domain | 10 bits = 72 | |
| information | (Number of | is 4 | bits | |
| (indicating | subcarriers = 192) | (Number of orthogonal vectors | | |
| an index of | A number of | for frequency domain = 4) | | |
| an | transmit antenna | A number of orthogonal | | |
| orthogonal | ports is 1024 | vectors for spatial domain is 4 | | |
| vector) | (Number of Tx | (Number of orthogonal vectors | | |
| Indicate | ports(UE) = 1024) | for spatial domain = 4) | | |
| orthogonal | A number of | A number of orthogonal | 4 * 8 bits + 2 * | 1X |
| vector | subcarriers is 192 | vectors for frequency domain | 5 bits + 2 * | |
| indexes | (Number of | is 4 | 4 bits = 50 | |
| | subcarriers = 192) | (Number of orthogonal vectors | bits | |
| | A number of | for frequency domain = 4) | | |
| | transmit antenna | A number of orthogonal | | |
| | ports is 1024 | vectors for horizontal antenna | | |
| | (Number of Tx | ports in spatial domain is 2 | | |
| | ports(UE) = 1024) | (Number of orthogonal vectors | | |
| | Spatial domain | for horizontal antenna ports in | | |
| | may be further | spatial domain = 2) | | |
| | divided into 32 * | A number of orthogonal | | |
| | 16 * 2 = 1024 | vectors for vertical antenna | | |
| | | ports in spatial domain is 2 | | |
| | | (Number of orthogonal vectors | | |
| | | for vertical antenna ports in | | |
| | | spatial domain = 2) | | |
| Bitmap | | | 1024 * 16 * | 3932X |
| bitmap | | | 12 = 196608 | |
| | | | bits | |

A difference between Table 3 and Table 2 lies in that spatial domain in Table 3 may be further divided into 32*16*2=1024, for example, divided into the horizontal antenna ports in spatial domain and the vertical antenna ports in spatial domain, and it is assumed that a same pattern is used for two polarization dimensions (same pattern for two polarization dimensions). It can be seen that, in comparison with the indication manner using a bitmap, in this disclosure, when a number of antennas is large, the M orthogonal vectors are indicated, to more significantly reduce indication overheads (reduce by 3932 times). In addition, when spatial domain is divided, indication overheads can also be reduced.

To implement functions in the method provided in this disclosure, an apparatus or a device provided in this disclosure may include a hardware structure and/or a software module. This implements the functions in a form of the hardware structure, the software module, or a combination of the hardware structure and the software module. Whether a function in the foregoing functions is performed in a form of the hardware structure, the software module, or both the hardware structure and the software module depends on a specific application and a design constraint condition of the technical solutions. Division into modules in this disclosure is an example, and is merely logical function division. During actual implementation, another division manner may be used. In addition, functional modules in embodiments of this disclosure may be integrated into one processor, or may exist alone physically, or two or more modules may be integrated into one module. The integrated module may be implemented in a form of hardware, or may be implemented in a form of a software functional module.

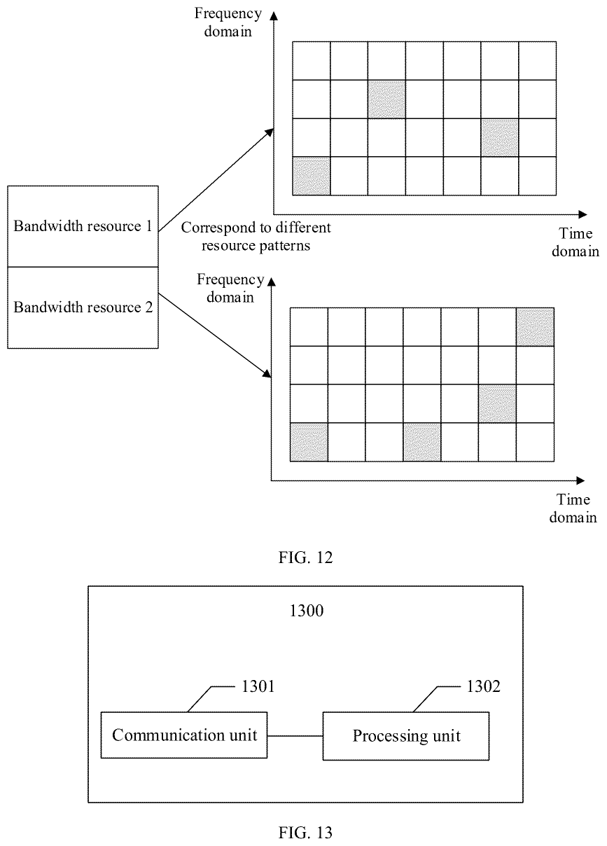

FIG. 13 is a diagram of a communication apparatus according to this disclosure. The apparatus may include a module that one-to-one corresponds to the method/operation/step/action described in any one of the embodiments shown in FIG. 3 to FIG. 12. The module may be a hardware circuit, or may be software, or may be implemented by a hardware circuit in combination with software.

The apparatus 1300 includes a communication unit 1301 and a processing unit 1302, configured to implement the method performed by each device in the foregoing embodiments. The communication unit 1301 is also referred to as a transceiver unit. The transceiver unit includes a sending unit and a receiving unit. The sending unit is configured to send a signal, and the receiving unit is configured to receive a signal.

In a possible implementation, the apparatus is a terminal, or is located in a terminal. Specifically, the communication unit 1301 is configured to receive first indication information, where the first indication information indicates M orthogonal vectors, and there is a mapping relationship between the M orthogonal vectors and a first resource pattern of an RS. The processing unit 1302 is configured to determine the first resource pattern of the RS based on the first indication information.

For specific execution procedures of the communication unit 1301 and the processing unit 1302 in this implementation, refer to the descriptions of the steps performed by the terminal in the foregoing method embodiments and related descriptions. Details are not described herein again. In the communication method implemented by the apparatus, a plurality of candidate orthogonal vectors or a method for generating a plurality of candidate orthogonal vectors may be predefined. In this case, the first indication information indicates the M orthogonal vectors in the plurality of candidate orthogonal vectors. Compared with a direct indication of the RS resource pattern, the indication of the M orthogonal vectors can significantly reduce indication overheads.

In a possible implementation, the apparatus is a network device, or is located in a network device. Specifically, the processing unit 1302 is configured to determine first indication information, where the first indication information indicates M orthogonal vectors, and there is a mapping relationship between the M orthogonal vectors and a first resource pattern of an RS. The communication unit 1301 is configured to send the first indication information.

For specific execution procedures of the communication unit 1301 and the processing unit 1302 in this implementation, refer to the descriptions of the steps performed by the network device in the foregoing method embodiments and related descriptions. Details are not described herein again. In the communication method implemented by the apparatus, the resource pattern of the RS may be flexibly indicated by changing one or more orthogonal vectors indicated by the first indication information. Compared with a direct indication of the RS resource pattern, the indication of the M orthogonal vectors can significantly reduce indication overheads of the RS.

In a possible implementation, the apparatus is a terminal, or is located in a terminal. Specifically, the communication unit 1301 is configured to send second indication information, where the second indication information indicates N orthogonal vectors, and there is a mapping relationship between the N orthogonal vectors and a second resource pattern of the RS. The processing unit 1302 is configured to determine a first resource pattern of the RS based on the second indication information, where the first resource pattern is the same as the second resource pattern.

For specific execution procedures of the communication unit 1301 and the processing unit 1302 in this implementation, refer to the descriptions of the steps performed by the terminal in the foregoing method embodiments and related descriptions. Details are not described herein again. In the communication method implemented by the apparatus, the terminal may determine the N orthogonal vectors, where there is also a mapping relationship between the N orthogonal vectors and the resource pattern of the RS. In addition, when the second resource pattern is the same as the first resource pattern, of the RS, determined by the second apparatus, the terminal does not need to receive the indication information, and may directly determine the first resource pattern of the RS based on the second indication information, to further reduce indication overheads of the RS.

In a possible implementation, when the communication apparatus is a chip, the chip includes a transceiver unit and a processing unit. The transceiver unit may be an input/output circuit or a communication interface. The processing unit is a processor, a microprocessor, an integrated circuit, or a logic circuit integrated on the chip.

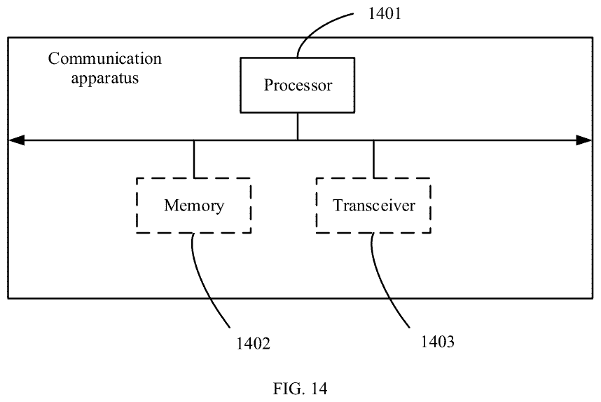

This disclosure further provides a communication apparatus. FIG. 14 is a diagram of another structure of a communication apparatus according to an embodiment of this disclosure. The communication apparatus may be configured to perform the steps performed by the first apparatus or the second apparatus in embodiments shown in FIG. 3 to FIG. 12. For details, refer to the related descriptions in the foregoing method embodiments.

The communication apparatus includes a processor 1401. Optionally, the communication apparatus further includes a memory 1402 and a transceiver 1403.

In a possible implementation, the processor 1401, the memory 1402, and the transceiver 1403 are connected to each other through a bus, and the memory stores computer instructions.

Optionally, the processing unit in the foregoing embodiment may specifically be the processor 1401 in this embodiment. Therefore, a specific implementation of the processor 1401 is not described again. The communication unit in the foregoing embodiment may be specifically the transceiver 1403 in this embodiment. Therefore, a specific implementation of the transceiver 1403 is not described again.

In this disclosure, the processor may be a general-purpose processor, a digital signal processor, an application-specific integrated circuit, a field programmable gate array or another programmable logic device, a discrete gate or transistor logic device, or a discrete hardware component, and may implement or perform the methods, steps, and logical block diagrams disclosed in this disclosure. The general-purpose processor may be a microprocessor or any other processor or the like. The steps of the methods disclosed with reference to this disclosure may be directly implemented by a hardware processor, or may be implemented by a combination of hardware and a software module in a processor.

In this disclosure, the memory may be a non-volatile memory, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in this disclosure may alternatively be a circuit or any other apparatus that can implement a storage function, and is configured to store program instructions and/or data.

This disclosure provides another communication apparatus. The device includes a processor and an interface. Optionally, the communication apparatus further includes a memory. The processor is coupled to the memory. The processor is configured to read and execute computer instructions stored in the memory, to implement the communication method in embodiments shown in FIG. 3 to FIG. 12.

An embodiment of this disclosure further provides a communication system. The communication system includes a first apparatus and a second apparatus. The first communication apparatus is configured to perform all or some of the steps performed by the first apparatus in the foregoing embodiments. The second apparatus is configured to perform all or some of the steps performed by the second apparatus in the foregoing embodiments.

This disclosure provides a computer-readable storage medium. The computer-readable storage medium stores a program or instructions. When the program or the instructions are run on a computer, the computer is enabled to perform the communication method in embodiments shown in FIG. 3 to FIG. 12.

This disclosure provides a computer program product. The computer program product includes instructions. When the instructions are run on a computer, the computer is enabled to perform the communication method in embodiments shown in FIG. 3 to FIG. 12.

This disclosure provides a chip or a chip system. The chip or the chip system includes at least one processor and an interface. The interface and the at least one processor are interconnected through a line. The at least one processor is configured to run a computer program or instructions, to perform the communication method in embodiments shown in FIG. 3 to FIG. 12.

The interface in the chip may be an input/output interface, a pin, a circuit, or the like.

The chip system may be a system on chip (SOC), a baseband chip, or the like. The baseband chip may include a processor, a channel encoder, a digital signal processor, a modem, an interface module, and the like.

In an implementation, the chip or the chip system described above in this disclosure further includes at least one memory, and the at least one memory stores instructions. The memory may be a storage unit inside the chip, for example, a register or a cache, or may be a storage unit (for example, a read-only memory (ROM) or a RAM) of the chip.

All or some of the technical solutions provided in this disclosure may be implemented by using software, hardware, firmware, or any combination thereof. When software is used to implement the technical solutions, all or a part of the technical solutions may be implemented in a form of a computer program product. The computer program product includes one or more computer instructions. When the computer program instructions are loaded and executed on the computer, the procedure or functions according to this disclosure are all or partially generated. The computer may be a general-purpose computer, a dedicated computer, a computer network, a network device, a terminal, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

In this disclosure, without a logical contradiction, mutual reference can be made between embodiments. For example, mutual reference can be made between methods and/or terms in method embodiments, mutual reference can be made between functions and/or terms in apparatus embodiments, and mutual reference can be made between functions and/or terms in the apparatus embodiments and the method embodiments.

It is clear that a person skilled in the art can make various modifications and variations to this disclosure without departing from the scope of this disclosure. This disclosure is intended to cover the modifications and variations of this disclosure, provided that they fall within the scope of the following claims and equivalent technologies of this disclosure.

What is claimed is:

1. A method, comprising:
receiving first indication information indicating M orthogonal vectors, wherein the M orthogonal vectors map to a first resource pattern of a reference signal, and wherein Mis a positive integer; and
determining, based on the first indication information, the first resource pattern.

2. The method of claim 1, wherein the first indication information comprises indexes of the M orthogonal vectors, dimensions of the M orthogonal vectors, or a first moment, and wherein the first moment corresponds to the indexes or the dimensions.

3. The method of claim 1, wherein one orthogonal vector set comprises the M orthogonal vectors, wherein all orthogonal vectors in the one orthogonal vector set correspond to a first candidate resource of the reference signal, wherein the first candidate resource comprises first resources in one or more domains, and wherein the one or more domains comprise one or more of a time domain, a frequency domain, or a spatial domain.

4. The method of claim 3, wherein the first resource pattern comprises second resources from the first candidate resource, and wherein a dimension of each of the M orthogonal vectors maps to a number of third resources in the first candidate resource.

5. The method of claim 4, wherein the dimension of each of the M orthogonal vectors is a number of fourth resources in one first domain when the first candidate resource is in the one first domain, and wherein the dimension is a product of numbers of fifth resources in a plurality of second domains when the first candidate resource is in the plurality of second domains.

6. The method of claim 3, wherein the M orthogonal vectors mapping to the first resource pattern comprises:
the first resource pattern comprises second candidate resources that correspond to a first group of linearly irrelevant row vectors of a first sub-unitary matrix, wherein arranging the M orthogonal vectors by column forms the first sub-unitary matrix, and wherein each row vector of the first sub-unitary matrix maps one-to-one to one of the second candidate resources; or
the first resource pattern comprises third candidate resources that correspond to a second group of linearly irrelevant column vectors of a second sub-unitary matrix, wherein arranging the M orthogonal vectors by row forms the second sub-unitary matrix, and wherein each column vector of the second sub-unitary matrix maps one-to-one to one of the third candidate resources.

7. The method of claim 1, wherein a plurality of orthogonal vector sets comprise the M orthogonal vectors, wherein all orthogonal vectors in each orthogonal vector set correspond to a same first candidate resource of the reference signal, wherein different orthogonal vector sets correspond to different second candidate resources of the reference signal, wherein the plurality of orthogonal vector sets collectively correspond to a combination of different third candidate resources of the reference signal, wherein the third candidate resources comprise first resources in one or more domains, and wherein the one or more domains comprise one or more of a time domain, a frequency domain, or a spatial domain.

8. The method of claim 7, wherein the first resource pattern comprises second resources from the first resources, and wherein a dimension of each orthogonal vector in any one of the plurality of orthogonal vector sets maps to a number of third resources in one of the third candidate resources corresponding to the orthogonal vector set.

9. The method of claim 8, wherein the dimension of each orthogonal vector in each orthogonal vector set is a number of fourth resources in one domain when the third candidate resources comprise a fifth resource in the one domain, and wherein the dimension of each orthogonal vector in each orthogonal vector set is a product of numbers of sixth resources in a plurality of domains when the third candidate resources comprise seventh resources in the plurality of domains.

10. The method of claim 7, wherein the M orthogonal vectors mapping to the first resource pattern comprises:
the first resource pattern comprises fourth candidate resources that correspond to a first group of linearly irrelevant row vectors of a first sub-unitary matrix, wherein each row vector of the first sub-unitary matrix maps one-to-one to the first resources in the combination of the third candidate resources that correspond to the plurality of orthogonal vector sets, wherein the first sub-unitary matrix is a first Kronecker product of a plurality of second sub-unitary matrices, wherein arranging first orthogonal vectors in one of the orthogonal vector sets by column forms each second sub-unitary matrix, and wherein each row vector of the second sub-unitary matrix maps one-to-one to one of the third candidate resources; or
the first resource pattern comprises fifth candidate resources that correspond to a second group of linearly irrelevant column vectors of a third sub-unitary matrix, wherein each column vector of the third sub-unitary matrix maps one-to-one to the first resources in the combination of the third candidate resources that correspond to the plurality of orthogonal vector sets, wherein a second Kronecker product of a plurality of fourth sub-unitary matrices forms the third sub-unitary matrix, wherein arranging second orthogonal vectors in one of the orthogonal vector sets by row forms each fourth sub-unitary matrix, and wherein each column vector of the fourth sub-unitary matrix maps one-to-one to one of the third candidate resources.

11. The method of claim 1, wherein before receiving the first indication information, the method further comprises:
determining second indication information indicating N orthogonal vectors, wherein the N orthogonal vectors map to a second resource pattern of the reference signal, and wherein N is a positive integer; and
sending the second indication information.

12. The method of claim 11, wherein the second indication information comprises indexes of the N orthogonal vectors, dimensions of the N orthogonal vectors, or a second moment, and wherein the second moment corresponds to the indexes or the dimensions.

13. The method of claim 1, further comprising receiving second indication information indicating one or more bandwidth resources, wherein the one or more bandwidth resources are associated with the first resource pattern.

14. The method of claim 13, wherein the one or more bandwidth resources comprise a first bandwidth resource and a second bandwidth resource, and wherein:
a second resource pattern corresponding to the second bandwidth resource is the same as a third resource pattern corresponding to the first bandwidth resource;
third indication information corresponding to the second bandwidth resource is the same as fourth indication information corresponding to the first bandwidth resource; or
one or more first orthogonal vectors corresponding to the second bandwidth resource are the same as one or more second orthogonal vectors corresponding to the first bandwidth resource.

15. The method of claim 1, further comprising sending second indication information indicating one or more bandwidth resources, wherein the one or more bandwidth resources are associated with a second resource pattern of the reference signal.

16. The method of claim 15, wherein the one or more bandwidth resources comprise a first bandwidth resource and a second bandwidth resource, and wherein:
a third resource pattern corresponding to the second bandwidth resource is the same as a fourth resource pattern corresponding to the first bandwidth resource;
third indication information corresponding to the second bandwidth resource is the same as fourth indication information corresponding to the first bandwidth resource; or
one or more first orthogonal vectors corresponding to the second bandwidth resource are the same as one or more second orthogonal vectors corresponding to the first bandwidth resource.

17. The method of claim 1, wherein the first indication information is configured by radio resource control (RRC), is indicated by downlink control information (DCI), or is indicated by a media access control control element (MAC-CE).

18. The method of claim 1, wherein an update period of the first indication information is periodic, aperiodic, or semi-persistent.

19. The method of claim 1, wherein an orthogonal vector set comprises orthogonal vectors from a discrete Fourier transform (DFT) matrix, a discrete cosine transform (DCT) matrix, or a Grassmannian manifold.

20. A method, comprising:
determining first indication information indicating M orthogonal vectors, wherein the M orthogonal vectors map to a first resource pattern of a reference signal, and wherein Mis a positive integer; and
sending the first indication information.
